(19) United States
(12) Patent Application Publication
(10) Pub. No.: US 2026/0004070 A1
(43) Pub. Date: Jan. 1, 2026

(54) DETECTING BREAKS IN SPEECH FOR CONVERSATIONAL AI SYSTEMS AND APPLICATIONS

(71) Applicant: NVIDIA Corporation, Santa Clara, CA (US)

(72) Inventors: Myungjong Kim, Milpitas, CA (US); Harishchandra Dubey, Snohomish, WA (US); Utkarsh Vaidya, Jabalpur (IN); Oluwatobi Olabiyi, Falls Church, VA (US)

(21) Appl. No.: 18/755,051

(22) Filed: Jun. 26, 2024

(51) Int. Cl. G06F 40/284; G10L 15/26

(52) U.S. Cl. CPC G06F 40/284; G10L 15/26

(57) ABSTRACT

In various examples, detecting breaks in speech for conversational AI systems and applications is described herein. Systems and methods are disclosed herein that use both end of sentence detection and end of utterance detection associated with words from text (e.g., tokens) to determine when to further process various portions of the text. For instance, one or more models may process text data associated with the text, where the text data may be generated using an automatic speech recognition (ARS) model based on audio data representing speech. Based at least on processing the text data, the model(s) may generate and/or output data representing first indicators that the words are associated with ends of sentences, second indicators that the words are associated with ends of utterances, and third indicators that the words are not associated with either ends of sentences or ends of utterances.

### BACKGROUND

Automatic speech recognition (ASR) may play an important role in conversational artificial intelligence (AI) systems and applications. For instance, ASR may convert audio data representing speech into tokens, such as tokens representing various portions of words (e.g., subwords), whole words, punctuation, symbols, letters, and/or so forth corresponding to the speech. Embeddings associated with these tokens may then be applied to one or more language models, such as one or more natural language models or one or more neural machine translation models, for further processing. In some circumstances, before applying the embeddings, a determination may be made of when the user is finished speaking such that an entirety of the text associated with the utterance may be applied to the language model(s). For instance, end of utterance detection may be used to try and accurately detect when the user has finished speaking. However, in some circumstances, an utterance may include multiple sentences, where a precision of the language model(s) may increase when portions of the utterance that are associated with these sentences are separately processed. While these conventional systems are able to detect the end of the utterance, these conventional systems that perform end of utterance detection may be unable to detect the endings of these sentences.

As such, other techniques have been used to detect the ends of sentences associated with an utterance. For example, some conventional systems may detect ends of sentences based on detecting capitalizations of words within utterances. However, in some circumstances, words that are included within the middle of sentences may be capitalized, such as when the words include names and/or specific locations. Additionally, other conventional systems may detect ends of sentences based on punctuation included in the utterances, such as periods and questions marks. However, in some circumstances, punctuation may be included in the middle of sentences, such as periods (e.g., “Mr.” or “Mrs.”). Furthermore, other conventional systems may detect ends of sentences based on pauses within the utterances. However, in some circumstances, it may be difficult to detect pauses between sentences based on how different users speak. Moreover, end of sentence detection techniques are unable to detect the ends of the utterances, which is still important for processing the text associated with the utterances.

### SUMMARY

Embodiments of the present disclosure relate to detecting breaks in speech for conversational AI systems and applications. Systems and methods are disclosed herein that use both end of sentence detection and end of utterance detection associated with words from text to determine when to further process various portions of the text. For instance, one or more models may process text data associated with the text (e.g., text data representing tokens corresponding to the text), where the text data may be generated using an automatic speech recognition (ARS) model and based at least on audio data representing speech. Based at least on processing the text data, the model(s) may generate and/or output data representing first indicators that the words (and/or tokens) are associated with ends of sentences, second indicators that the words (and/or tokens) are associated with ends of utterances, and third indicators that the words (and/or tokens) are not associated with either ends of sentences or ends of utterances. This output may then be used to detect locations of ends of sentences and/or ends of utterances, where these locations cause the portions of the text to be further processed. In some examples, the systems and methods may use one or more additional techniques to determine these locations, such as one or more models that perform case detection and/or one or more models that perform punctuation detection.

In contrast to conventional systems, the systems of the present disclosure may use both end of sentence detection and end of utterance detection together to determine locations within text (e.g., tokens) for further processing. This way, the systems of the present disclosure are able to detect ends of sentences when an utterance include multiple sentences as well as an end of the utterance, which may improve the performance of the language model(s) by processing specific portions of the text as compared to the conventional systems that just use case detection, punctuation detection, and/or pause detection. Additionally, and as will be described in more detail herein, the systems of the present disclosure use the model(s) that is trained to detect both the ends of sentences and ends of utterances, where this training may improve the performance of the model(s).

### BRIEF DESCRIPTION OF THE DRAWINGS

The present systems and methods for detecting breaks in speech for conversational AI systems and applications are described in detail below with reference to the attached drawing figures, wherein:

FIG. 1 illustrates an example of a first process of performing break detection in speech, in accordance with some embodiments of the present disclosure;

FIG. 2 illustrates an example of performing end of sentence detection and end of utterance detection associated with speech, in accordance with some embodiments of the present disclosure;

FIG. 3 illustrates another example of performing end of sentence detection and end of utterance detection associated with speech, in accordance with some embodiments of the present disclosure;

FIG. 4 illustrates a data flow diagram illustrating a process for training one or more models to perform break detection in speech, in accordance with some embodiments of the present disclosure;

FIG. 5 illustrates an example of a second process of performing break detection in speech using one or more additional models, in accordance with some embodiments of the present disclosure;

FIGS. 6A-6B illustrate an example of performing case detection associated with speech, in accordance with some embodiments of the present disclosure;

FIGS. 7A-7B illustrate an example of performing punctuation detection associated with speech, in accordance with some embodiments of the present disclosure;

FIG. 8 illustrates a data flow diagram illustrating another process for training one or more models to perform break detection in speech, in accordance with some embodiments of the present disclosure;

FIG. 9 illustrates an example of a third process of performing break detection in speech using fusion, in accordance with some embodiments of the present disclosure;

FIG. 10 illustrates an example of a system that may perform one or more of the processes described herein, in accordance with some embodiments of the present disclosure;

FIG. 11 illustrates a flow diagram showing a method for determining at least an end of sentence and an end of utterance associated with tokens, in accordance with some embodiments of the present disclosure;

FIG. 12 illustrates a flow diagram showing a method for performing break detection is speech, in accordance with some embodiments of the present disclosure;

FIG. 13 illustrates a flow diagram showing a method for determining ends of sentences and ends of utterances associated with speech, in accordance with some embodiments of the present disclosure;

FIG. 14A is a block diagram of an example generative language model system suitable for use in implementing some embodiments of the present disclosure;

FIG. 14B is a block diagram of an example generative language model that includes a transformer encoder-decoder suitable for use in implementing some embodiments of the present disclosure;

FIG. 14C is a block diagram of an example generative language model that includes a decoder-only transformer architecture suitable for use in implementing some embodiments of the present disclosure;

FIG. 15 is a block diagram of an example computing device suitable for use in implementing some embodiments of the present disclosure; and

FIG. 16 is a block diagram of an example data center suitable for use in implementing some embodiments of the present disclosure.

### DETAILED DESCRIPTION

Systems and methods are disclosed related to detecting breaks in speech for conversational systems and applications. For instance, a system(s) may generate, obtain, receive, determine, and/or retrieve audio data representing speech from a user. As described herein, the speech may be associated with an utterance, such as an utterance that includes one or more sentences. For example, the speech may be associated an utterance such as “Good morning, John. How are you?”. The system(s) may then process the audio data using one or more techniques to generate text data associated with the speech. For instance, in some examples, the system(s) may process the audio data using one or more models (referred to, in some examples, as the “first model(s)”) associated with automatic speech recognition (ASR) to generate the text data. As such, in some examples, the text data may be associated with a text transcript of the speech, such as by representing the words, style, punctuation, and/or the like that matches the speech. Additionally, in some examples, the text may be represented using one or more tokens, such as one or more tokens that represent portions of words, words, punctuation, symbols, letters, and/or so forth from the text.

In some examples, the system(s) may then further process the text data, such as by using one or more language models. As described herein, the language model(s) may include, but is not limited to, one or more natural language models, one or more neural machine translation models, one or more large language models, and/or any other type of language model. In some examples, such as to improve the performance of the language model(s) processing the text data, the system(s) may be configured to determine one or more locations within the text that are associated with breaks for processing the text data, such as one or more ends of sentences and/or one or more ends of utterances within the text. For example, if the utterance includes two sentences, such as similar to the example above, the system(s) may process a first portion of the text data that is associated with the first sentence (e.g., “Good morning, John”) at a first instance followed by processing at least a second portion of the text data that is associated with the second sentence (e.g., “How are you”) and/or an entirety of the utterance (e.g., “Good morning, John. How are you?”) at a second instance.

For instance, the system(s) may process the text data using one or more encoders (e.g., one or more text encoders) that are configured to generate one or more embeddings corresponding to the text (e.g., the tokens). The system(s) may then apply data representing the embedding(s) to one or more models (also referred to, in some examples, as the “second model(s)”) that are trained to perform both end of sentence (EOS) detection and end of utterance (EOU) detection. For instance, based at least on processing the data, the second model(s) may generate and/or output data representing one or more first indicators that the words from the text (and/or the tokens representing the text) are associated with an EOS, one or more second indicators that the words from the text (and/or the tokens representing the text) are associated with an EOU, and/or one or more third indicators that the words from the text (and/or the tokens representing the text) are not associated with an EOS or an EOU (e.g., also referred to as “normal words”). In some examples, the indicators may be associated with probabilities that the words are associated with an EOS, an EOU, or a normal word. For example, and for a word, the output data may represent at least a first probability that the word is associated with an EOS, a second probability that the word is associated with an EOU, and a third probability that the word is associated with a normal word.

The system(s) (and/or the second model(s)) may then use the indicators to determine one or more locations within the text that are associated with an EOS or an EOU. For a first example, and using the example above where the word is associated with the three probabilities, the system(s) may determine that the word is associated with an EOS location based at least on the first probability including a highest probability and/or the first probability satisfying a threshold probability. For a second example, and again using the example above where the word is associated with the three probabilities, the system(s) may determine that the word is associated with an EOU location based at least on the second probability including a highest probability and/or the second probability satisfying the threshold probability. Still, for a third example, and again using the example above where the word is associated with the three probabilities, the system(s) may determine that the word is associated with a normal word location (e.g., not associated with an EOS location or an EOU location) based at least on the third probability including a highest probability, the third probability satisfying the threshold probability, and/or the first probability and/or the second probability not satisfying the threshold probability. While these are just a few example techniques of how the system(s) may detect the EOS and/or EOU location(s), in other examples, the system(s) may use additional and/or alternative techniques.

In some examples, the system(s) may perform one or more additional techniques for detecting the EOS and/or the EOU location(s) within the text. For instance, in some examples, the system(s) may apply the data representing the embedding(s) to one or more models (also referred to, in some examples, as the “third model(s)”) that are trained to perform case detection. For instance, based at least on processing the data, the third model(s) may generate and/or output data representing one or more first indicators that the words from the text (and/or the tokens representing the text) are associated with lowercase words and/or one or more second indicators that the words from the text (and/or the tokens representing the text) are associated with uppercase words. In some examples, the indicators may be associated with probabilities that the words are associated with lowercase words and/or uppercase words. For example, and for a word, the output data may represent at least a first probability that the word is associated with a lowercase word and a second probability that the word is associated with an uppercase word.

The system(s) may then use the indicators to further identify the EOS and/or EOU location(s) within the text. For a first example, and using the example above where the word is associated with the two probabilities, the system(s) may determine that a previous word is more likely to be associated with an EOS location when the second probability includes a highest probability and/or satisfies a threshold probability. In some examples, this may be because the third model(s) indicates that the word includes an uppercase word, which may indicate a start of a new sentence such that the previous word is the end of the previous sentence. For a second example, and again using the example above where the word is associated with the two probabilities, the system(s) may determine that a previous word is less likely to be associated with an EOS location and/or an EOU location when the first probability includes a highest probability and/or satisfies the threshold probability. In some examples, this may be because the third model(s) indicates that the word includes a lowercase word, which may indicate a middle of a sentence. While these are just a few example techniques of how the system(s) may use the case detections to further detect the EOS and/or EOU location(s), in other examples, the system(s) may use additional and/or alternative techniques.

Additionally, or alternatively, in some examples, the system(s) may apply the data representing the embedding(s) to one or more models (also referred to, in some examples, as the “fourth model(s)”) that are trained to perform punctuation detection. For instance, based at least on processing the data, the fourth model(s) may generate and/or output data representing one or more first indicators that the words from the text (and/or the tokens representing the text) are associated with one or more types of punctuation marks and/or one or more second indicators that the words from the text (and/or the tokens representing the text) are not associated with one or more punctuation marks. In some examples, the indicators may be associated with probabilities that the words are associated with the type(s) of punctuation marks and/or no punctuation marks. For example, and for a word, the output data may represent at least a first probability that the word is associated with a first type of punction mark (e.g., a period), a second probability that the word is associated with a second type of punction mark (e.g., a comma), and/or so forth until and a last probability that the word is not associated with a punctuation mark.

The system(s) may then use the indicators to further identify the EOS and/or EOU location(s) within the text. For a first example, the system(s) may determine that the word is more likely to be associated with an EOS location and/or an EOU location when a probability that is associated with punctuation marks for end of sentences (e.g., periods, question marks, exclamation marks, etc.) includes a highest probability and/or satisfies a threshold probability. For a second example, the system(s) may determine that the word is less likely to be associated with an EOS location and/or an EOU location when a probability that is associated with punctuation marks for middles of sentences (e.g., commas, etc.) includes a highest probability and/or satisfies the threshold probability. Still, for a third example, the system(s) may determine that the word is less likely to be associated with an EOS location and/or an EOU location when a probability that is associated with no punctuation marks includes a highest probability and/or satisfies the threshold probability. While these are just a few example techniques of how the system(s) may use the punctuation detections to further detect the EOS and/or EOU location(s), in other examples, the system(s) may use additional and/or alternative techniques.

Additionally, or alternatively, in some examples, the system(s) may further process the audio data using one or more encoders (e.g., one or more audio encoders) in order to generate one or more additional embeddings associated with the speech. The system(s) may then perform one or more fusion techniques to fuse the embedding(s) associated with the text with the additional embedding(s) associated with the speech in order to generate one or more input embeddings. For instance, the system(s) may then input data representing the input embedding(s) into the second model(s), the third model(s), and/or the fourth model(s) in addition to, or alternatively from, the embedding(s) associated with the text.

As described herein, in some examples, the system(s) may perform one or more techniques to train the second model(s), the third model(s), and/or the fourth model(s). For a first example, if the system(s) just uses the second model(s), the system(s) may generate, obtain, receive, determine, and/or retrieve training data representing instances of text associated with various utterances as well as ground truth data representing indicators associated with the instances of text, such as indicators indicating whether words are associated with EOSs, EOUs, and/or normal words. The system(s) may then apply data associated with the instances of text (e.g., data representing embeddings associated with tokens corresponding to the text) into the second model(s) that processes the data and, based at least on the processing, generates outputs indicating indicators for the instances of text. Additionally, the system(s) may determine one or more losses using the ground truth indicators and the output indicators. The system(s) may then update the second model(s) using the loss(es).

For a second example, if the system(s) uses the second model(s), the third model(s), and/or the fourth model(s), the system(s) may generate, obtain, receive, determine, and/or retrieve training data representing instances of text associated with various utterances as well as ground truth data representing indicators associated with the instances of text. For instance, the indicators may indicate whether words are associated with EOSs, EOUs, normal words, lowercase words, uppercase words, include punctuation marks, and/or do not include punctuation marks. The system(s) may then apply data associated with the instances of text (e.g., data representing embeddings associated with tokens corresponding to the text) into the second model(s), the third model(s), and/or the fourth model(s) that process the data and, based at least on the processing, generate outputs indicating indicators for the instances of text, which are described herein. Additionally, the system(s) may determine one or more losses using the ground truth indicators and the output indicators. The system(s) may then update the second model(s), the third model(s), and/or the fourth model(s) using the loss(es).

While the examples herein describe detecting EOSs and/or EOUs associated with words from text, in other examples, similar processes may be used to detect EOSs and/or EOUs associated with the tokens corresponding to the text. For example, similar processes may be used to determine indicators for the tokens using the second model(s), the third model(s), and/or the fourth model(s). These indicators may then be used to determine the EOSs and EOUs, using one or more of the processes described herein. Additionally, the locations of the EOSs and/or EOUs may then be used to partition the text data representing the tokens into portions for further processing. Although described as using one, two, three, four, or more models, this is not intended to mean discrete models must be used, but that there may discrete models, or there may be different layers (or heads—e.g., sets of layers) for each different task. For example, there may be a punctuation head, an EOS head, an EOU head, a case head, etc., without departing from the scope of the present disclosure.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing vision language models (VLMs), systems for implementing multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

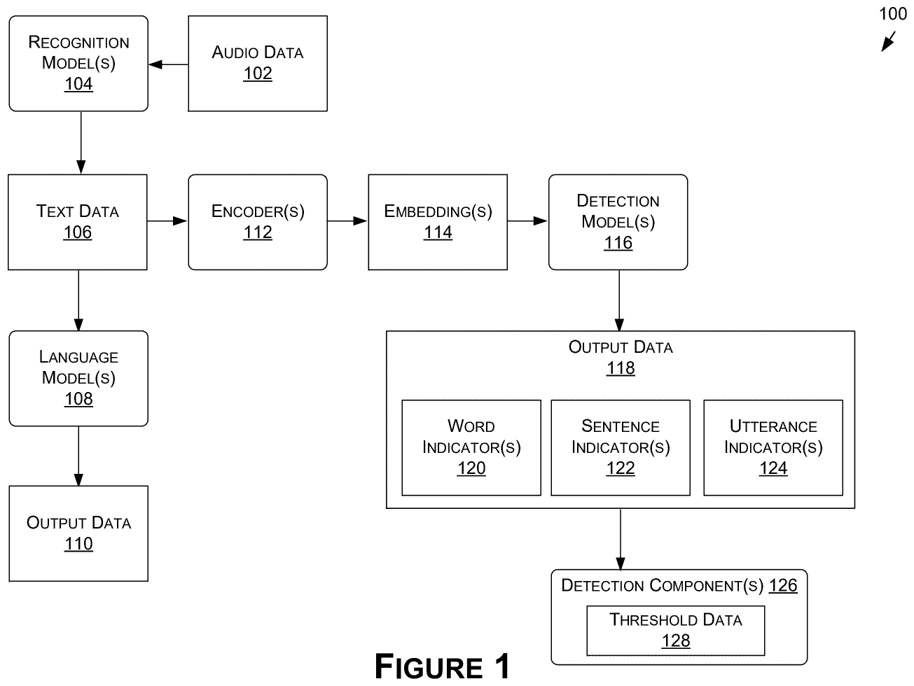

With reference to FIG. 1A, FIG. 1 illustrates an example of a first process 100 of performing break detection in speech, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include applying audio data 102 to one or more recognition models 104. As described herein, the audio data 102 may represent speech, such as an utterance that includes one or more sentences from one or more users. For example, the audio data 102 may represent an utterance such as “Good morning, John. How are you?”. Additionally, the recognition model(s) 104 may include any type of machine learning model, neural network, component, module, software, hardware, and/or the like that is configured to process the audio data 102 and, based at least on the processing, generate text data 106 that is associated with text corresponding the speech. For instance, the recognition model(s) 104 may include one or more automatic speech recognition models that are configured to generate the text data 106 that is associated with a transcript of the speech. As such, the text data 106 may represent one or more text tokens associated with the text, such as text tokens that represent different letters, numbers, punctuation, word portions, words, symbols, and/or the like associated with the speech.

In some examples, the process 100 may then include applying the text data 106 to one or more language models 108. As described herein, the language model(s) 108 may include, but is not limited to, one or more natural language models, one or more neural machine translation models, one or more large/vision/multi-modal language models, and/or any other type of language model that is configured to process the text data 106 in order to generate output data 110 associated with the speech. For instance, the utterance represented by the audio data 102 may include a query, a request, a command, a question, an instruction, and/or any other type of utterance and the output data 110 may represent a response, information, another question, and/or the like associated with the utterance. For example, and using the example above where the utterance includes “Good morning, John. How are you?”, the output data 110 may represent a response to the utterance, such as “I am doing well.”

As described herein, in some examples, such as to improve the performance of the language model(s) 108 processing the text data 106, locational breaks associated with the text (e.g., the tokens) may be used to apply various portions of the text data 106 to the language model(s) 108 at different instances in time. For instance, portions of the text data 106 that are associated with one or more ends of sentences and/or one or more ends of utterances within the text may be applied to the language model(s) 108 at different instances in time. For a first example, and using the example above, a first portion of the text data 106 representing the first sentence (e.g., “Good morning, John”) may be applied to the language model(s) 108 at a first instance in time followed by a second portion of the text data 106 representing the second sentence (e.g., “How are you”) at a second instance in time. For a second example, and again using the example above, a first portion of the text data 106 representing the first sentence (e.g., “Good morning, John”) may be applied to the language model(s) 108 at a first instance in time followed by a second portion of the text data 106 representing an entirety of the utterance (e.g., “Good morning, John. How are you?”) at a second instance in time.

As such, the process 100 may include processing at least a portion of the text data 106 using one or more encoders 112, such as one or more text encoders, that are configured to generate one or more embeddings 114 (e.g., one or more vectors) representing the text data 106. For example, if the text data 106 represents the token(s), then the embedding(s) 114 may be generated by the encoder(s) 112 to represent token(s). While the example of FIG. 1 illustrates using the encoder(s) 112 to generate the embedding(s) 114, in other examples, the process 100 may not include using the encoder(s) 112. Rather, the process 100 may include further processing the text data 106 using one or more of the techniques described herein (e.g., the models may include one or more encoders that process the text data 106).

For instance, and as shown, the process 100 may include applying the embedding(s) 114 to one or more detection models 116. As described herein, in some examples, the detection model(s) 116 may include, but is not limited to, one or more machine learning models, one or more neural networks, one or more layers (e.g., one or more connected layers, one or more output layers, etc.) of one or more models, one or more heads of one or more models, software, hardware, and/or any other type of processing component that is configured to perform at least a portion of the processes described herein. For instance, based at least on processing the embedding(s) 114, the process 100 may include the detection model(s) 116 generating and/or outputting output data 118 associated with the speech. For instance, and as shown, the output data 118 may represent at least one or more word indicators 120 associated with the speech (e.g., normal words that are not associated with an end of sentence and/or an end of utterance), one or more end of sentence (EOS) indicators 122 associated with the speech, and/or one or more end of utterance (EOU) indicators 124 associated with the speech.

As described herein, in some examples, the output data 118 may represent a respective word indicator 120, an EOS indicator 122, and a EOU indicator associated with one or more (e.g., each) of the words from the speech (and/or one or more (e.g., each) of the tokens represented by the text data 106). For instance, and using the example above, the output data 118 may represent a first word indicator 120, a first EOS indicator 122, and a first EOU indicator 124 associated with the first word “Good”, a second word indicator 120, a second EOS indicators 122, and a second EOU indicator 124 associated with the second word “morning,”, a third word indicator 120, a third EOS indicator 122, and a third EOU indicator 124 associated with the third word “John.”, and/or so forth for the rest of the words included in the utterance.

As described herein, in some examples, the word indicators 120, the EOS indicators 122, and/or the EOU indicators 124 may be associated with various probabilities. For instance, and again using the example above, the first word indicator 120 may include a first probability that the first word is associated with a normal word, the first EOS indicator 122 may include a second probability that the first word is associated with an EOS, and the first EOU indicator 124 may include a third probability that the first word is associated with an EOU. Additionally, the second word indicator 120 may include a fourth probability that the second word is associated with a normal word, the second EOS indicator 122 may include a fifth probability that the second word is associated with an EOS, and the second EOU indicator 124 may include a sixth probability that the second word is associated with an EOU. In such an example, the probabilities may total a maximum probability, such as 100% (and/or any other probability). For example, the first probability may include 95%, the second probability may include 2%, and the third probability may include 3%.

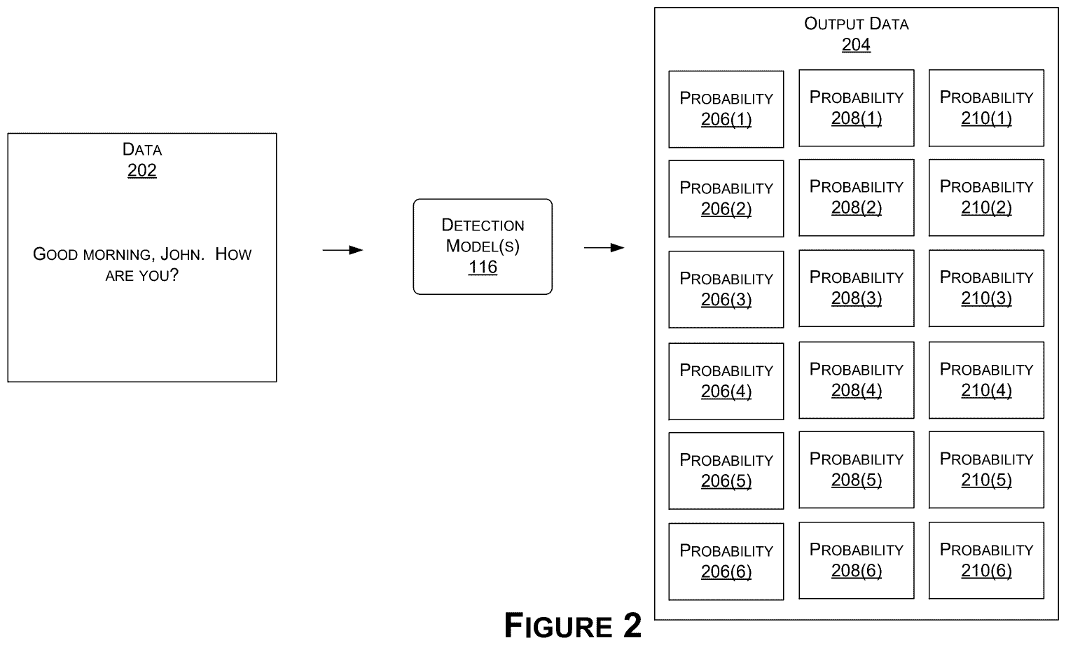

For instance, FIG. 2 illustrates an example of performing end of sentence and end of utterance detection associated with speech, in accordance with some embodiments of the present disclosure. As shown, data 202 (embeddings) corresponding to an utterance, “Good morning, John. How are you?”, may be applied to the detection model(s) 116. As such, the detection model(s) 116 may perform one or more of the processes described herein in order to generate output data 204 (which may be similar to, and/or represent, the output data 118) associated with the data 202. For instance, and as shown, the output data 204 may represent probabilities 206(1)-(6) that the six words are associated with normal words, probabilities 208(1)-(6) that the six words are associated with EOSs, and probabilities 210(1)-(6) that the six words are associated with EOUs. For example, the probability 206(3) may include 2% that the third word “John.” is associated with a normal word, the probability 208(3) may include 95% that the third word is associated with an EOS, and the probability 210(3) may include 3% that the third word is associated with an EOU.

While the example of FIG. 2 illustrates the text as including uppercase letters along with punctuation, in other examples, the text associated with the data 202 may not include uppercase letters and/or punctuations. For example, the text may include “good morning john how are you”. Additionally, while the example of FIG. 2 illustrates determining the output data 204 (e.g., the probabilities) associated with the individual words of the text, in other examples, similar processes may be used to determine probabilities associated with individual tokens corresponding to the text. For example, the probability 206(1) may be associated with a token corresponding to a normal word, the probability 208(1) may be associated with the token corresponding to an EOS word, and the probability 210(1) may be associated with the token corresponding to an EOU word.

Referring back to the example of FIG. 1, the process 100 may include one or more detection components 126 processing the output data 118 in order to detect EOS and/or EOU locations associated with speech. As described herein, in some examples, the detection component(s) 126 may include, but is not limited to, one or more machine learning models, one or more neural networks, one or more layers (e.g., one or more connected layers, one or more output layers, etc.) of one or more models, one or more heads of one or more models, one or more modules, software, hardware, and/or any other type of processing component that is configured to perform at least a portion of the processes described herein. Additionally, in some examples, the detection component(s) 126 may detect an EOS location based at least on a probability associated with the EOS indicator 122 including a highest probability and/or satisfying (e.g., being equal to or greater than) a threshold probability, where the threshold probability may be represented by threshold data 128. Furthermore, in some examples, the detection component(s) 126 may detect an EOU location based at least on a probability associated with the EOU indicator 124 including a highest probability and/or satisfying (e.g., being equal to or greater than) the threshold probability. As described herein, a threshold probability may include, but is not limited to, 75%, 95%, 99%, and/or any other percentage.

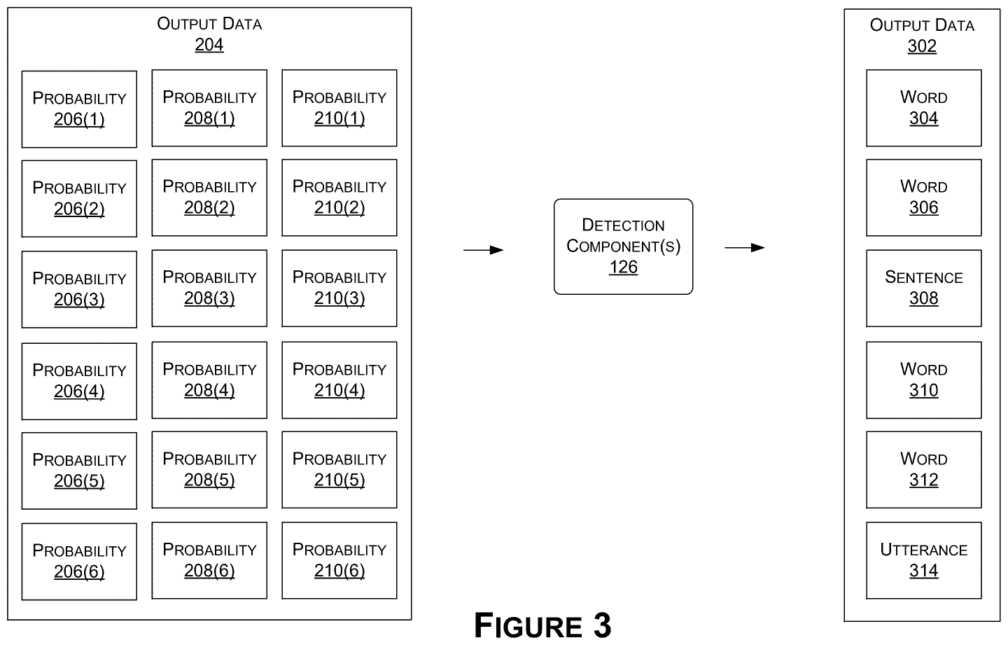

For instance, FIG. 3 illustrates another example of performing end of sentence and end of utterance detection associated with speech, in accordance with some embodiments of the present disclosure. As shown, the detection component(s) 126 may process the output data 204 and, based at least on the processing, output data 302 representing detections associated with the words from the speech. For instance, the detection component(s) 126 may determine that the probability 206(1) includes a highest probability among the probabilities 206(1), 208(1), and 210(1) and/or that the probability 206(1) satisfies the threshold probability. As such, the detection component(s) 126 may determine that the first word includes a normal word 304. The detection component(s) 126 may then determine that the probability 206(2) includes a highest probability among the probabilities 206(2), 208(2), and 210(2) and/or that the probability 206(2) satisfies the threshold probability. As such, the detection component(s) 126 may determine that the second word includes a normal word 306. The detection component(s) 126 may then determine that the probability 208(3) includes a highest probability among the probabilities 206(3), 208(3), and 210(3) and/or that the probability 208(3) satisfies the threshold probability. As such, the detection component(s) 126 may determine that the third word includes an EOS location 308.

The detection component(s) 126 may then determine that the probability 206(4) includes a highest probability among the probabilities 206(4), 208(4), and 210(4) and/or that the probability 206(4) satisfies the threshold probability. As such, the detection component(s) 126 may determine that the fourth word includes a normal word 310. The detection component(s) 126 may then determine that the probability 206(5) includes a highest probability among the probabilities 206(5), 208(5), and 210(5) and/or that the probability 206(5) satisfies the threshold probability. As such, the detection component(s) 126 may determine that the fifth word includes a normal word 312. The detection component(s) 126 may then determine that the probability 210(6) includes a highest probability among the probabilities 206(6), 208(6), and 210(6) and/or that the probability 210(6) satisfies the threshold probability. As such, the detection component(s) 126 may determine that the sixth word includes an EOU location 314.

In some examples, the output from the detection component(s) 126 may include one or more letters, numbers, characters, punctuation marks, and/or any other type of identifier. For example, the normal word 304, 306, 310, and 312 indicators may include a first identifier, the EOS location 308 indicator may include a second identifier, and the EOU location 314 indicator may include a third identifier.

Referring back to the example of FIG. 1, the process 100 may include causing the language model(s) 108 to process the text data 106 based at least on the detections from the detection component(s) 126. For instance, and as described herein, at least a portion of the text data 106 may be applied to the language model(s) 108 for processing when an EOS location and/or an EOU location is detected. In some examples, the applying of the text data 106 to the language model(s) 108 may be performed using one or more techniques. For a first example, a portion of the text data 106 that represents a sentence may applied to the language model(s) 108 when an EOS location is detected while an entirety to the text data 106 that represents the utterance may be applied to the language model(s) 108 when an EOU location is detected. For a second example, a portion of the text data 106 that represents a first word to a specific word associated with an EOS location and/or an EOS location may be applied to the language model(s) 108 each time an EOS location and/or an EOU location is detected. While these are just a few example techniques for how the text data 106 may be applied to the language model(s) 108, in other examples, the text data 106 may be applied using additional and/or alternative techniques.

While the example of FIG. 1 illustrates the recognition model(s) 104, the encoder(s) 112, the detection model(s) 116, and the detection component(s) 126 as being separate from one another, in other examples, the recognition model(s) 104, the encoder(s) 112, the detection model(s) 116, and the detection component(s) 126 may be combined, such as into one or more machine learning models. For example, a model may include at least the encoder(s) 112, the layers of the detection model(s) 116, and/or the layers of the detection component(s) 126.

Additionally, while the example of FIG. 1 describes performing the process 100 when a user speaks a single language, in other examples, the process 100 may be work for multiple languages. For example, if a user is switching between different languages, a first recognition model 104 may be configured to generate first text data 106 corresponding to a first language and a second recognition model 104 may be configured to generate second text data 106 corresponding to a second language (e.g., using code that causes the automatic switching between the recognition models 14). In such an example, the detection model(s) 116 may be trained to process the first text data 106 in order to generate first output data 118 that includes one or more first word indicators 120 associated with the first language, one or more first sentence indicators 122 associated with the first language, and/or one or more first utterance indicators 124 associated with the first language. Additionally, the detection model(s) may be trained to process the second text data 106 in order to generate second output data 118 that includes one or more second word indicators 120 associated with the second language, one or more second sentence indicators 122 associated with the second language, and/or one or more second utterance indicators 124 associated with the second language. This way, the process 100 may be used to still detect an EOS(s) and/or an EOU(s) associated with the utterance(s) even when the user is speaking in different languages.

Additionally, while the example of FIG. 1 describes performing the process 100 when a single user that is speaking, in other examples, the process 100 may work when multiple users are speaking. For example, the recognition model(s) 104 may generate first text data 106 associated with first speech from a first user (e.g., a primary user) and/or second text data 106 associated with second speech from a second user (e.g., a second user, an interfering user, a background user, etc.). The detection component(s) 116 may then process the first text data 106 in order to generate first output data 118 that includes one or more first word indicators 120 associated with the first speech, one or more first sentence indicators 122 associated with the first speech, and/or one or more first utterance indicators 124 associated with the first speech. Additionally, or alternatively, the detection model(s) may process the second text data 106 in order to generate second output data 118 that includes one or more second word indicators 120 associated with the second speech, one or more second sentence indicators 122 associated with the second speech, and/or one or more second utterance indicators 124 associated with the second speech. This way, the process 100 may still be used to detect an EOS(s) and/or an EOU(s) associated with multiple utterances from multiple users.

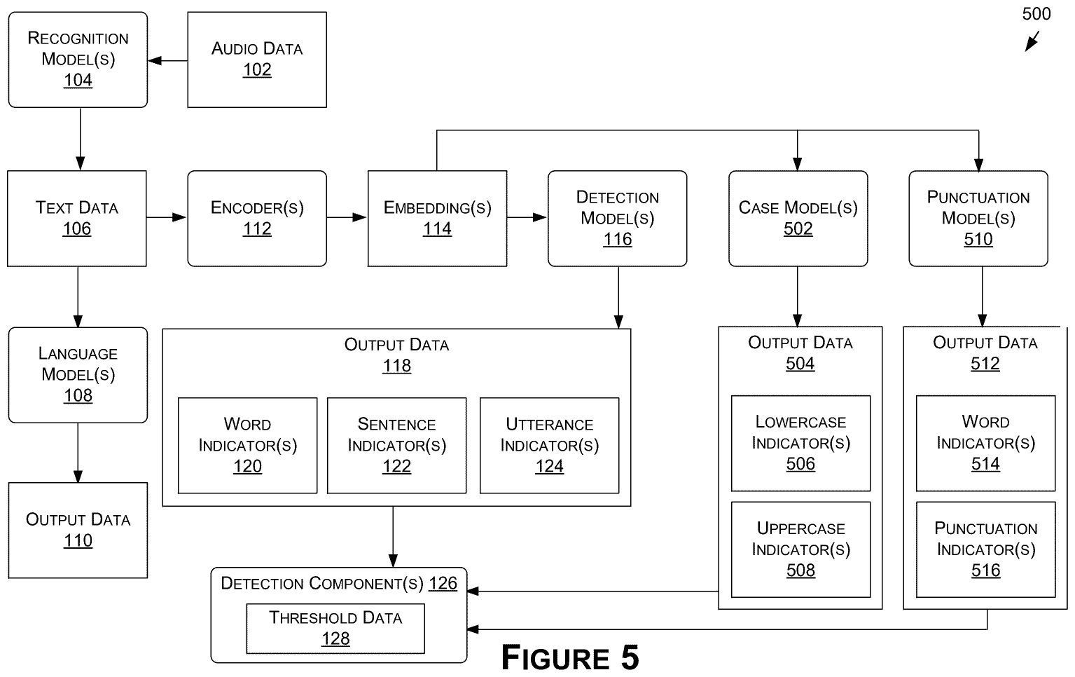

In other words, the process 100 (and/or similarly the process 500 described with respect to the example of FIG. 5) may be performed when any number of users are speaking, when any language is being spoken, and/or when different languages are being spoken by one or more users.

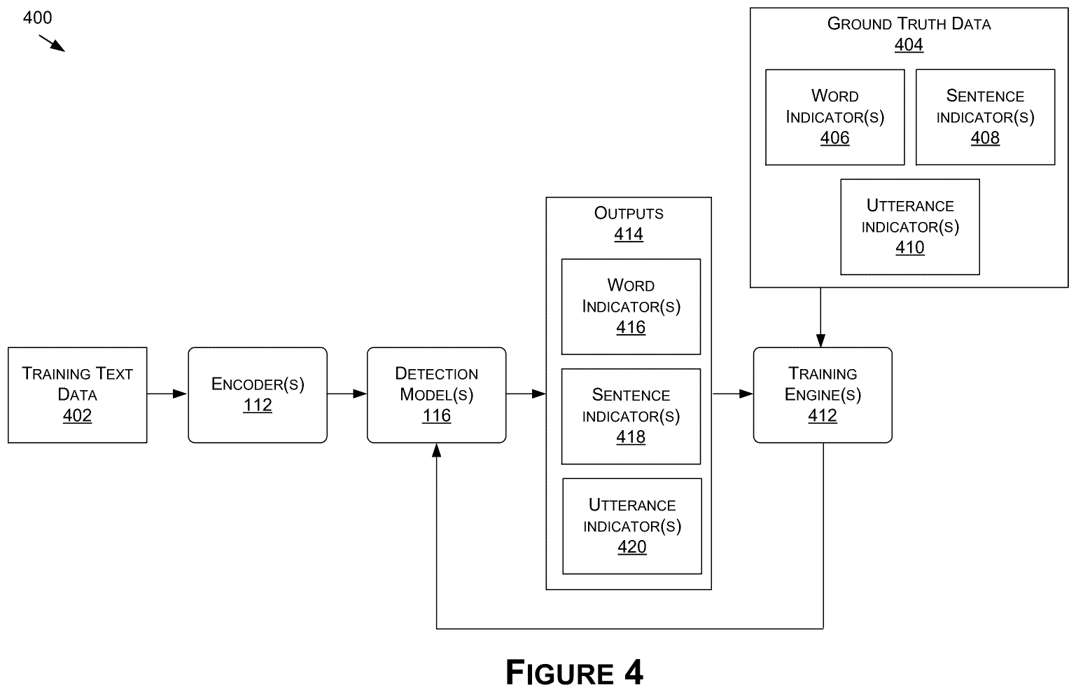

FIG. 4 illustrates a data flow diagram illustrating a process 400 for training the detection model(s) 116 to perform break detection, in accordance with some embodiments of the present disclosure. As shown, the detection model(s) 116 may be trained using training text data 402. In some examples, the training text data 402 may include instances of text that are associated with utterances, which may be similar to and/or include the text data 106. The training text data 402 may be synthetically produced (e.g., generated from computer models or renderings), real produced (e.g., designed and produced from real-world data, such as audio data), machine-automated (e.g., using feature analysis and learning to extract features from data and then generate labels), human annotated (e.g., labeler, or annotation expert, defines the location of the labels), and/or a combination thereof.

The detection model(s) 116 may be trained using the training text data 402 as well as corresponding ground truth data 404. The ground truth data 404 may include annotations, labels, masks, and/or the like. For instance, and as shown, the ground truth data 404 may include at one or more word indicators 406, one or more EOS indicators 408, and/or one or more EOU indicators 410 associated with the instances of text. The ground truth data 404 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the training text data 402, there may be corresponding ground truth data 404.

As further illustrated in the example of FIG. 4, a training engine 412 may use one or more loss functions that measure loss (e.g., error) in outputs 414 as compared to the ground truth data 404. In some examples, the outputs 414 may be similar to and/or include the output data 118. For example, the outputs 414 may include at least one or more word indicators 416, one or more EOS indicators 418, and/or one or more EOU indicators 420 associated with the instances of text. Any type of loss function may be used, such as cross entropy loss, mean squared error, mean absolute error, mean bias error, and/or other loss function types. In some examples, different outputs 414 may have different loss functions. For example, the word indicator(s) 416 may include a first loss function and/or first loss, the EOS indicator(s) 418 may include a second loss function and/or second loss, and/or the EOU indicator(s) 420 may include a third loss function and/or third loss. In such examples, the loss functions may be combined to form a total loss (where one or more losses may be weighted), and the total loss may be used to train (e.g., update the parameters of) the detection model(s) 116. In any example, backward pass computations may be performed to recursively compute gradients of the loss function(s) with respect to training parameters. In some examples, weights and/or biases of the detection model(s) 116 may be used to compute these gradients.

FIG. 5 illustrates an example of a second process 500 of performing break detection in speech using one or more additional models, in accordance with some embodiments of the present disclosure. As shown, in addition to the process 100, the process 500 may further include applying the embedding(s) 114 to one or more case models 502. As described herein, in some examples, the case model(s) 502 may include, but is not limited to, one or more machine learning models, one or more neural networks, one or more layers (e.g., one or more connected layers, one or more output layers, etc.) of one or more models, one or more heads of one or more models, software, hardware, and/or any other type of processing component that is configured to perform at least a portion of the processes described herein. For instance, based at least on processing the embedding(s) 114, the process 500 may include the case model(s) 502 generating and/or outputting output data 504 associated with the speech. For instance, and as shown, the output data 504 may represent at least one or more lowercase indicators 506 associated with the speech and/or one or more uppercase indicators 508 associated with the speech.

As described herein, in some examples, the output data 504 may represent a respective lowercase indicator 506 and uppercase indicator 508 associated with one or more (e.g., each) of the words from the speech (and/or one or more (e.g., each) of the tokens represented by the text data 106). For instance, and using the example above, the output data 504 may represent a first lowercase indicator 506 and a first uppercase indicator 508 associated with the first word “Good”, a second lowercase indicator 506 and a second uppercase indicators 508 associated with the second word “morning,”, a third lowercase indicator 506 and a third uppercase indicator 508 associated with the third word “John.”, and/or so forth for the rest of the words included in the utterance.

Additionally, in some examples, the lowercase indicators 506 and/or the uppercase indicators 508 may be associated with various probabilities. For instance, and again using the example above, the first lowercase indicator 506 may include a first probability that the first word is lowercase and the first uppercase indicator 508 may include a second probability that the first word is uppercase. Additionally, the second lowercase indicator 506 may include a third probability that the second word is lowercase and the second uppercase indicator 508 may include a fourth probability that the second word is uppercase. In such examples, the probabilities may total a specific probability, such as 100% (and/or any other probability). For example, the first probability may include 95% and the second probability may include 5%.

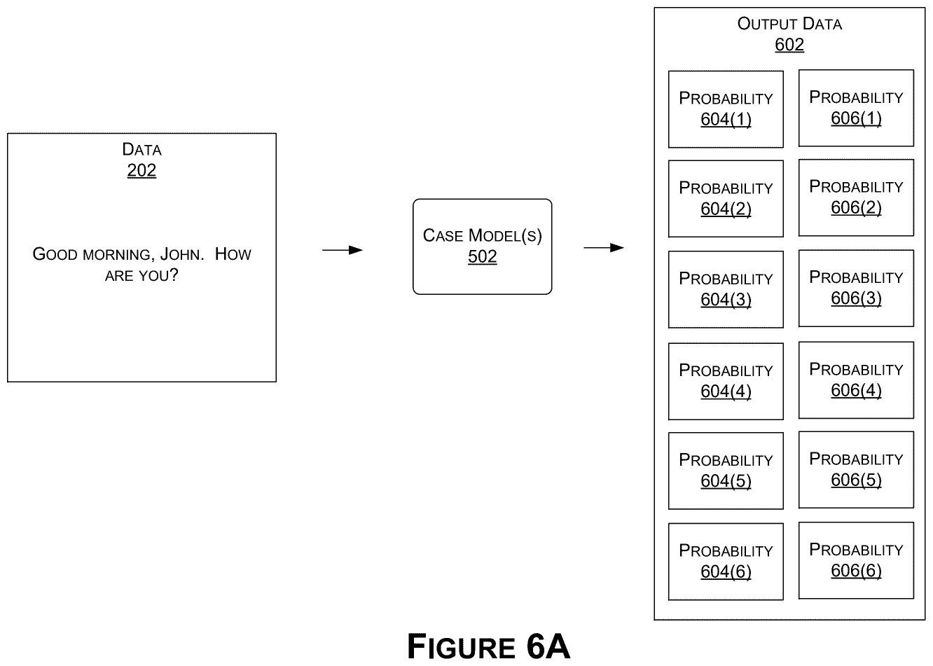

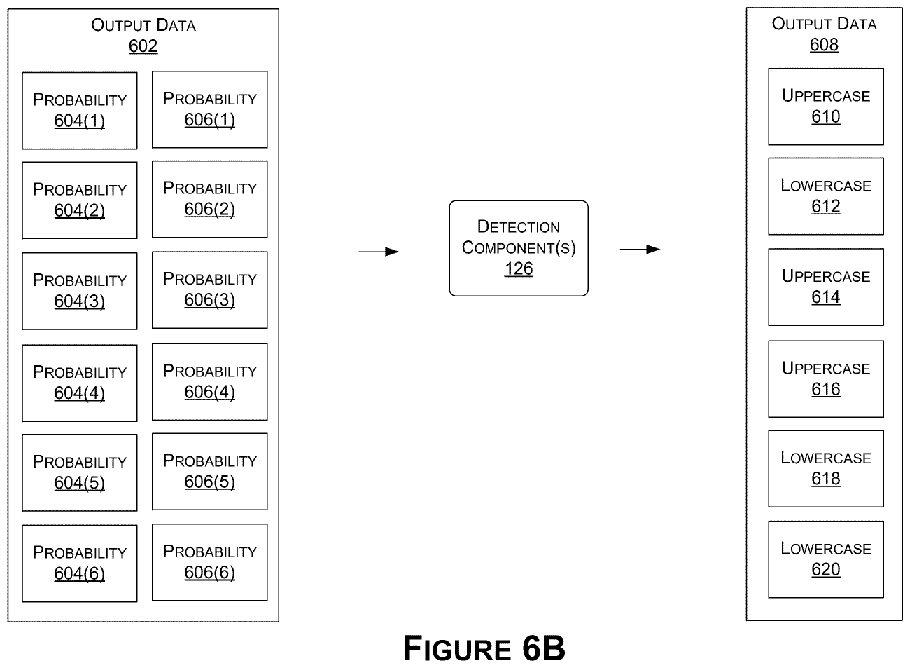

For instance, FIGS. 6A-6B illustrate an example of performing case detection associated with speech, in accordance with some embodiments of the present disclosure. As shown by the example of FIG. 6A, the data 202 (e.g., embeddings) from the example of FIG. 2 may also be applied to the case model(s) 502. As such, the case model(s) 502 may perform one or more of the processes described herein in order to generate output data 602 (which may be similar to, and/or represent, the output data 504) associated with the utterance corresponding to the text 202. For instance, and as shown, the output data 602 may represent probabilities 604(1)-(6) that the six words are lowercase and probabilities 606(1)-(6) that the six words are uppercase. For example, the probability 604(4) may include 2% that the fourth word “How” is lowercase and the probability 606(4) may include 98% that the fourth word is uppercase.

While the example of FIG. 6A illustrates determining the output data 602 (e.g., the probabilities) associated with the individual words of the text, in other examples, similar processes may be used to determine probabilities associated with individual tokens corresponding to the text. For example, the probability 604(1) may be associated with a token corresponding to a lowercase word and the probability 606(1) may be associated with the token corresponding to an uppercase word.

Referring back to the example of FIG. 5, the process 500 may include the detection component(s) 126 further processing the output data 504 in order to detect the EOS locations and/or EOU locations associated with speech. For a first example, and using the example above where the word is associated with the two probabilities, the detection component(s) 126 may determine that a previous word is more likely to be associated with an EOS location and/or an EOU location when the second probability includes the highest probability and/or satisfies a threshold probability. In some examples, this may be because the case model(s) 502 indicates that the word includes an uppercase word, which may indicate a start of a new sentence such that the previous word is the end of the previous sentence. For a second example, and again using the example above where the word is associated with the two probabilities, the detection component(s) 126 may determine that a previous word is less likely to be associated with an EOS location and/or an EOU location when the first probability includes a highest probability and/or satisfies the threshold probability. In some examples, this may be because the case model(s) 502 indicates that the word includes a lowercase word, which may indicate a middle of a sentence. While these are just a few example techniques of how the detection component(s) 126 may use the case detections to further detect the EOS and/or EOU location(s), in other examples, the detection component(s) 126 may use additional and/or alternative techniques.

For instance, FIG. 6B illustrates another example of performing case detection associated with speech, in accordance with some embodiments of the present disclosure. As shown, the detection component(s) 126 may use the output data 602 in order to generate output data 608 representing indicators of whether the words are lowercase or uppercase. For instance, the detection component(s) 126 may determine that the first word is uppercase 610 based at least on the probability 606(1) including a highest probability and/or satisfying the threshold probability, the second word is lowercase 612 based at least on the probability 604(2) including a highest probability and/or satisfying the threshold probability, the third words is uppercase 614 based at least on the probability 606(3) including a highest probability and/or satisfying the threshold probability, the fourth word is uppercase 616 based at least on the probability 606(4) including a highest probability and/or satisfying the threshold probability, the fifth word is lowercase 618 based at least on the probability 604(5) including a highest probability and/or satisfying the threshold probability, and/or the sixth words is lowercase 620 based at least on the probability 604(6) including a highest probability and/or satisfying the threshold probability. The detection component(s) 126 may then use the output data 608 when generating the output data 302 from the example of FIG. 3.

While the example of FIG. 6B illustrates generating the output data 608 for the individual words, in other examples, the detection component(s) 126 may generate similar output data 608 for individual tokens associated with the text corresponding to the words. Additionally, as described herein, the output data 608 may represent one or more letters, numbers, characters, punctuation marks, and/or any other type of identifier. For example, the lowercase 612, 618, and 620 indicators may include a first identifier and the uppercase 610, 614, and 616 indicators may include a second identifier.

Referring back to the example of FIG. 5, the process 500 may further include applying the embedding(s) 114 to one or more punctuation models 510. As described herein, in some examples, the punctation model(s) 510 may include, but is not limited to, one or more machine learning models, one or more neural networks, one or more layers (e.g., one or more connected layers, one or more output layers, etc.) of one or more models, one or more heads of one or more models, software, hardware, and/or any other type of processing component that is configured to perform at least a portion of the processes described herein. For instance, based at least on processing the embedding(s) 114, the process 500 may include the punctuation model(s) 510 generating and/or outputting output data 512 associated with the speech.

As shown, in some examples the output data 512 may represent at least one or more word indicators 514 associated with the speech and/or one or more punctuation indicators 516 associated with the speech. As described herein, in some examples, a word indicator 514 may indicate that a word does not include any punctuation marks while a punctuation indicator 516 may indicate that a word does include a punctuation mark and/or indicate a type of punctuation mark. As described herein, a type of punctuation mark may include, but is not limited to, a period, an exclamation mark, a question mark, a comma, and/or any other type of punctuation mark.

Additionally, in some examples, the word indicator 514 and/or the punctuation indicator 516 may be associated with various probabilities. For instance, and for a word, a word indicator 514 may indicate a first probability that the word is not associated with any punctuation marks, a first punctuation indicator 516 may indicate a second probability that the word is associated with a first type of punctuation mark (e.g., a period), a second punctuation indicator 516 may indicate a third probability that the word is associated with a second type of punctuation mark (e.g., an exclamation mark), a third punctuation indicator 516 may indicate a fourth probability that the word is associated with a third type of punctuation mark (e.g., a question mark), a fourth punctuation indicator 516 may indicate a fifth probability that the word is associated with a fourth type of punctuation mark (e.g., a comma), and/or so forth. In some examples, the probabilities may total a specific probability, such as 100% (and/or any other probability).

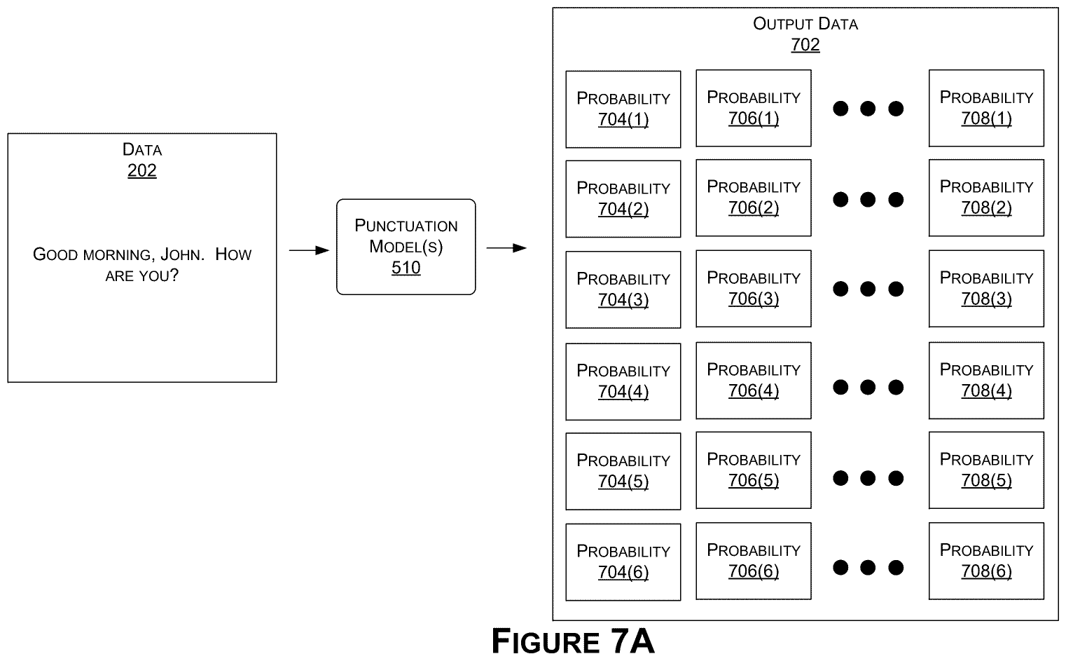

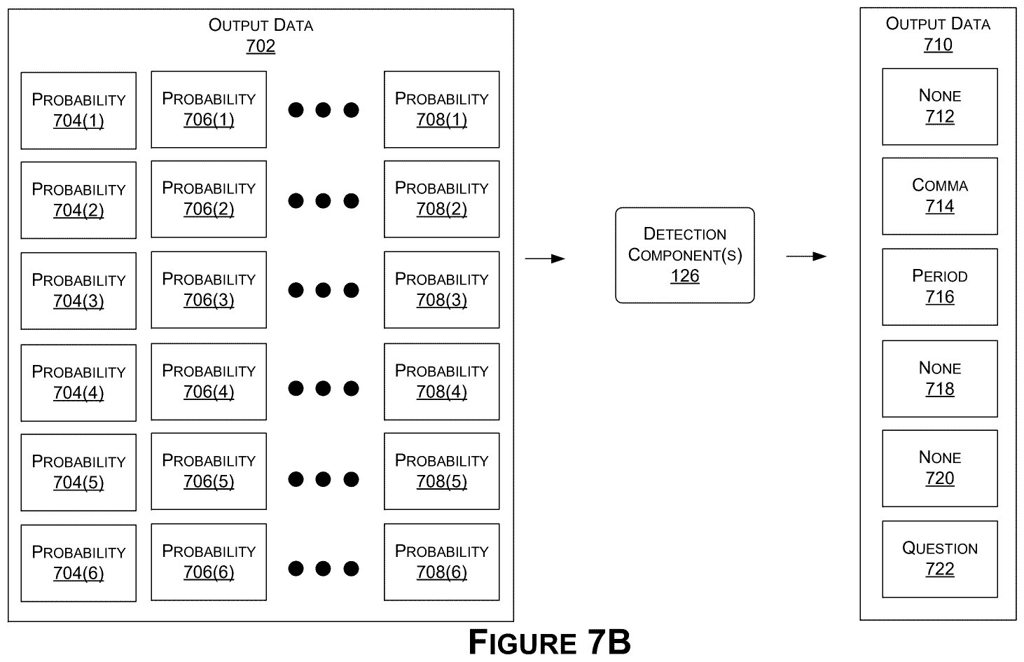

For instance, FIGS. 7A-7B illustrate an example of performing punctuation detection associated with speech, in accordance with some embodiments of the present disclosure. As shown by the example of FIG. 7A, the data 202 (e.g., embeddings) from the example of FIG. 2 may also be applied to the punctuation model(s) 510. As such, the punctuation model(s) 510 may perform one or more of the processes described herein in order to generate output data 702 (which may be similar to, and/or represent, the output data 512) associated with the data 202. For instance, and as shown, the output data 702 may represent probabilities 704(1)-(6) that the six words are associated with no punctuation marks, probabilities 706(1)-(6) that the six words are associated with a first type of punctuation mark, and so forth until probabilities 708(1)-(6) that the six words are associated with a last type of punctuation mark.

While the example of FIG. 7A illustrates determining the output data 702 (e.g., the probabilities) associated with the individual words of the text, in other examples, similar processes may be used to determine probabilities associated with individual tokens corresponding to the text. For example, the probability 704(1) may be associated with a token corresponding to no punctuation marks, the probability 706(1) may be associated with the token corresponding to the first type of punctuation mark, and/or so forth until the probability 708(1) may be associated the token corresponding to a last type of punctuation mark.

Referring back to the example of FIG. 5, the process 500 may include the detection component(s) 126 further processing the output data 512 in order to detect EOS locations and/or EOU locations associated with speech. For a first example, the detection component(s) 126 may determine that the word is more likely to be associated with an EOS location and/or an EOU location when a probability that is associated with punctuation marks for ends of sentences (e.g., periods, question marks, exclamation marks, etc.) includes a highest probability and/or satisfies a threshold probability. For a second example, the detection component(s) 126 may determine that the word is less likely to be associated with an EOS location and/or an EOU location when a probability that is associated with punctuation marks for middles of sentences (e.g., commas, etc.) includes a highest probability and/or satisfies the threshold probability. Still, for a third example, the detection component(s) 126 may determine that the word is less likely to be associated with an EOS location and/or an EOU location when a probability that is associated with no punctuation marks includes a highest probability and/or satisfies the threshold probability. While these are just a few example techniques of how the detection component(s) 126 may use the punctuation detections to further detect the EOS and/or EOU location(s), in other examples, the detection component(s) 126 may use additional and/or alternative techniques.

For instance, FIG. 7B illustrates another example of performing punctuation detection associated with speech, in accordance with some embodiments of the present disclosure. As shown, the detection component(s) 126 may use the output data 702 in order to generate output data 710 representing indicators of whether the words include punctuation marks. For instance, the detection component(s) 126 may determine that the first word includes no punctuation marks 712 based at least on the probability 704(1) including a highest probability and/or satisfying the threshold probability. Additionally, the detection component(s) 126 may determine that the second word includes a first type of punctuation mark (e.g., a comma 714) based at least on the probability 706(2) including a highest probability and/or satisfying the threshold probability. The detection component(s) 126 may then perform similar processes to determine that the third word includes a period 716, the fourth word includes no punctuation marks 718, the fifth word includes no punctuation marks 720, and the sixth word includes a question mark 722. The detection component(s) 126 may then use the output data 710 when generating the output data 302 from the example of FIG. 3.

While the example of FIG. 7B illustrates generating the output data 710 for the individual words, in other examples, the detection component(s) 126 may generate similar output data 710 for individual tokens associated with the text corresponding to the words. Additionally, as described herein, the output data 710 may represent one or more letters, numbers, characters, punctuation marks, and/or any other type of identifier. For example, the no punctuation marks 712, 718, and 720 may include a first identifier, the comma 714 may include a second identifier, the period 716 may include a third identifier, and the question mark 722 may include a fourth identifier.

Referring back to the example of FIG. 5, while the example of FIG. 5 illustrates the recognition model(s) 104, the encoder(s) 112, the detection model(s) 116, the detection component(s) 126, the case model(s) 502, and the punctuation model(s) 510 as being separate from one another, in other examples, the recognition model(s) 104, the encoder(s) 112, the detection model(s) 116, the detection component(s) 126, the case model(s) 502, and/or the punctuation model(s) 510 may be combined, such as into one or more machine learning models. For example, a model may include at least the encoder(s) 112, the layers of the detection model(s) 116, the layers of the case model(s) 502, the layers of the punctuation model(s) 510, and/or the layers of the detection component(s) 126.

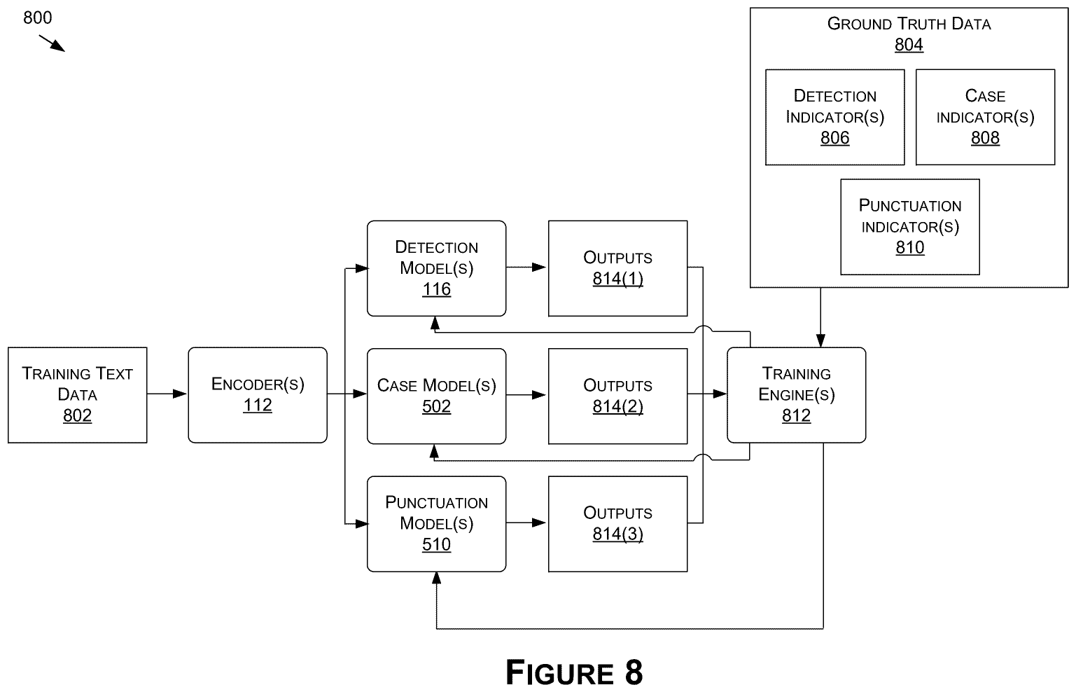

FIG. 8 illustrates a data flow diagram illustrating a process 800 for training the detection model(s) 116, the case model(s) 502, and/or the punctuation model(s) 510 to perform break detection, in accordance with some embodiments of the present disclosure. As shown, the detection model(s) 116, the case model(s) 502, and/or the punctuation model(s) 510 may be trained using training text data 802. In some examples, the training text data 802 may include instances of text that are associated with utterances, which may be similar to and/or include the text data 106 and/or the training text data 402. The training text data 802 may be synthetically produced (e.g., generated from computer models or renderings), real produced (e.g., designed and produced from real-world data, such as audio data), machine-automated (e.g., using feature analysis and learning to extract features from data and then generate labels), human annotated (e.g., labeler, or annotation expert, defines the location of the labels), and/or a combination thereof.

The detection model(s) 116, the case model(s) 502, and/or the punctuation model(s) 510 may also be trained using corresponding ground truth data 804. The ground truth data 804 may include annotations, labels, masks, and/or the like. For instance, and as shown, the ground truth data 804 may include at least one or more detection indicators 806, one or more case indicators 808, and/or one or more punctuation indicators 810. The ground truth data 804 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the training text data 802, there may be corresponding ground truth data 804.

In some examples, the detection indicator(s) 806 may indicate one or more normal words, one or more EOS words, and one or more EOU words, such as similar to the word indicator(s) 406, the EOS indicator(s) 408, and the EOU indicator(s) 410 from the example of FIG. 4. Additionally, in some examples, the case indicator(s) 808 may indicator whether one or more words are lowercase and/or whether one or more words are uppercase, such as similar to the lowercase indicator(s) 506 and/or the uppercase indicator(s) 508 from the example of FIG. 5. Furthermore, in some examples, the punctuation indicator(s) 810 may indicate whether one or more words are associated with punctuation marks and/or one or more types of punctuation marks that one or more words are associated with, such as similar to the word indicator(s) 514 and/or the punctuation indicator(s) 516 from the example of FIG. 5.

As further illustrated in FIG. 8, one or more training engines 812 may use one or more loss functions that measure loss (e.g., error) in outputs 814(1)-(3) as compared to the ground truth data 804. In some examples, the outputs 814(1) may be similar to and/or include the output data 118, the outputs 814(2) may be similar to and/or include the output data 504, and/or the outputs 814(3) may be similar to and/or include the output data 512. Any type of loss function may be used, such as cross entropy loss, mean squared error, mean absolute error, mean bias error, and/or other loss function types. In some examples, different outputs 814(1)-(3) may have different loss functions. For example, a first loss function may be used and/or a first loss may be determined based at least on comparing the outputs 814(1) to the detection indicator(s) 806, a second loss function may be used and/or a second loss may be determined based at least on comparing the outputs 814(2) to the case indicator(s) 808, and/or a third loss function may be used and/or a third loss may be determined based at least on comparing the outputs 814(3) to the punctuation indicator(s) 810.

In some examples, when determining different losses, the loss functions and/or the losses may be combined to form a total loss (where one or more losses may be weighted), and the total loss may be used to train (e.g., update the parameters of) the detection model(s) 116, the case model(s) 502, and/or the punctuation model(s) 510. However, in other examples, the first loss function and/or the first loss may be used to train the detection model(s) 116, the second loss function and/or the second loss may be used to train the case model(s) 502, and/or the third loss function and/or the third loss may be used to train the punctuation model(s) 510 In any example, backward pass computations may be performed to recursively compute gradients of the loss function(s) with respect to training parameters. In some examples, weights and biases of the detection model(s) 116, the case model(s) 502, and/or the punctuation model(s) 510 may be used to compute these gradients.

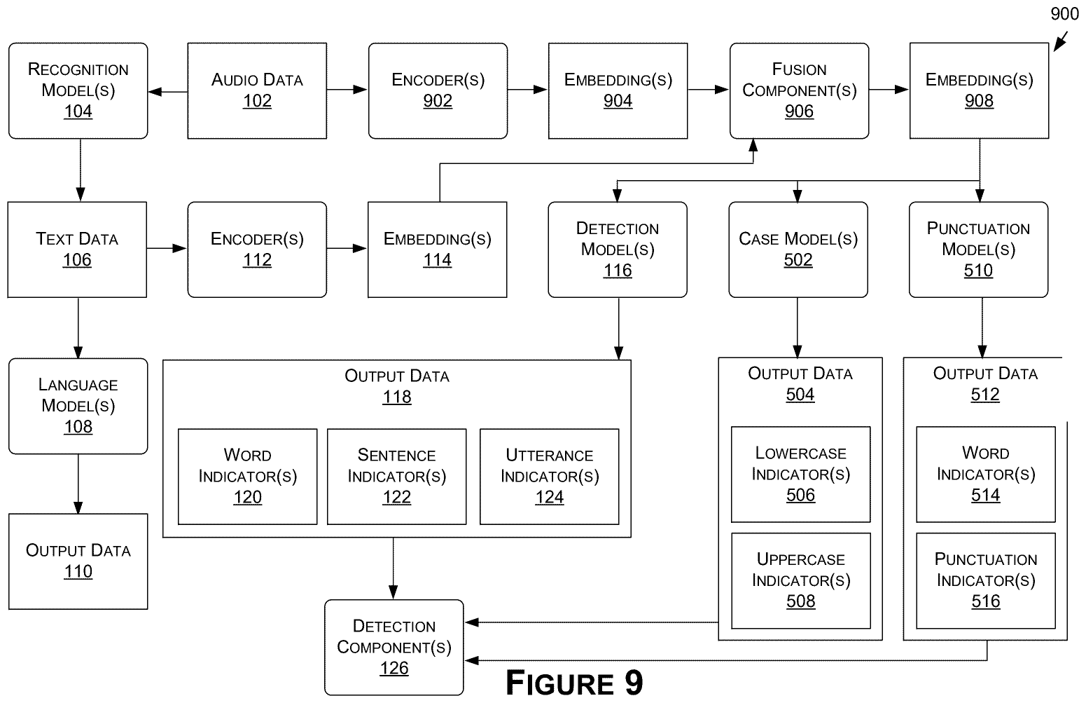

FIG. 9 illustrates an example of a third process 900 of performing break detection in speech using fusion, in accordance with some embodiments of the present disclosure. As shown, in addition to the process 100 and/or the process 500, the process 900 may further include processing at least a portion of the audio data 102 using one or more encoders 902, such as one or more audio encoders, that are configured to generate one or more embeddings 904 representing the audio data 102. As described herein, in some examples, the encoder(s) 902 may include any type of audio encoder that is able to generate the embedding(s) 904 based at least on processing the audio data 102.

As further illustrated in the example of FIG. 9, the process 900 may include using one or more fusion components 906 to process at least a portion of the embedding(s) 114 and/or at least a portion of the embedding(s) 904. Based at least on the processing, the process 900 may include the fusion component(s) 906 generating one or more additional embeddings 908 to be applied to the detection model(s) 116, the case model(s) 502, and/or the punctuation model(s) 510. For instance, the fusion component(s) 906 may generate the embedding(s) 908 by combining, fusing, mixing, and/or performing any other type of process with respect to the embedding(s) 114 and the embedding(s) 904.

While the example of FIG. 9 illustrates adding the encoder(s) 902 and the fusion component(s) 906, in other examples, the encoder(s) 902 and/or the fusion component(s) 906 may be added to the example of FIG. 1. For instance, the process 100 may use the encoder(s) 902 and the fusion component(s) 906, where the embedding(s) 908 is then just applied to the detection model(s) 116. Additionally, in some examples, the process 900 may not include one or more of the case model(s) 502 and/or the punctuation model(s) 510.

As described herein, in some examples, at least one of the recognition model(s) 104, the language model(s) 108, the encoder(s) 112, the detection model(s) 116, the detection component(s) 126, the case model(s) 502, the punctuation model(s) 510, the encoder(s) 902, and/or the fusion component(s) 906 may be stored on and/or executed by one or more computing devices. For example, at least one of the recognition model(s) 104, the language model(s) 108, the encoder(s) 112, the detection model(s) 116, the detection component(s) 126, the case model(s) 502, the punctuation model(s) 510, the encoder(s) 904, and/or the fusion component(s) 908 may be stored in one or more memories and/or executed by one or more processors of a computing device(s) 1500 and/or an example data center(s) 1600, which are described in more detail herein.

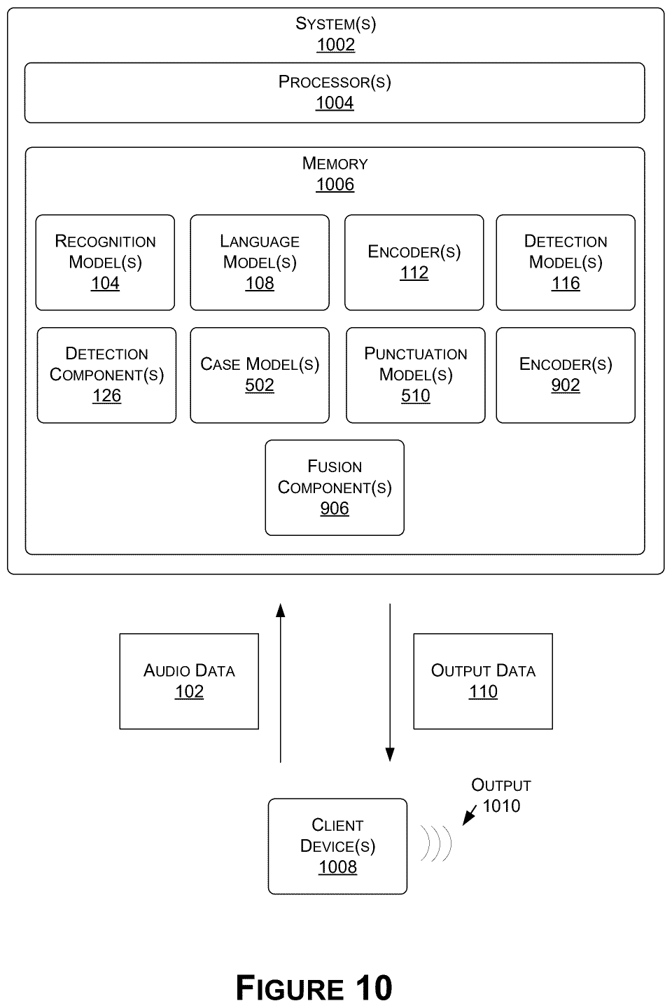

For instance, FIG. 10 illustrates an example of a system 1000 that may perform one or more of the processes described herein, in accordance with some embodiments of the present disclosure. As shown, the system 1000 (which may represent, and/or include, an example computing device(s) 1500 and/or an example data center 1600) may include one or more processors 1102 (which may be similar to, and/or include, one or more central processing units 1506 and/or one or more graphics processing units 1508) and memory 1006 (which may be similar to, and/or include, a memory 1504). For instance, the memory 1006 may store the recognition model(s) 104, the language model(s) 108, the encoder(s) 112, the detection model(s) 116, the detection component(s) 126, the case model(s) 502, the punctuation model(s) 510, the encoder(s) 902, and/or the fusion component(s) 906. Additionally, the processor(s) 1004 may execute the recognition model(s) 104, the language model(s) 108, the encoder(s) 112, the detection model(s) 116, the detection component(s) 126, the case model(s) 502, the punctuation model(s) 510, the encoder(s) 902, and/or the fusion component(s) 906 to perform one or more of the processes described herein.

Additionally, as shown by the example of FIG. 10, the system 1000 may receive the audio data 102 from one or more client device 1008 (which may also be similar to, and/or include, an example computing device 1500) and/or send the output data 110 to the client device(s) 1008. For instance, the client device(s) 1008 may use one or more input devices, such as one or more microphones, to generate the audio data 102. The client device(s) 1008 may also include one or more output devices, such as one or more speakers, to output 1010 sound associated with the output data 110. For instance, in some examples, the audio data 102 may represent a query and the output data 110 may represent a response to the query. While the example of FIG. 10 illustrates the output 1010 as being associated with audio, in other examples, the output may include any other type of output, such as content that is displayed by the client device(s) 1008.

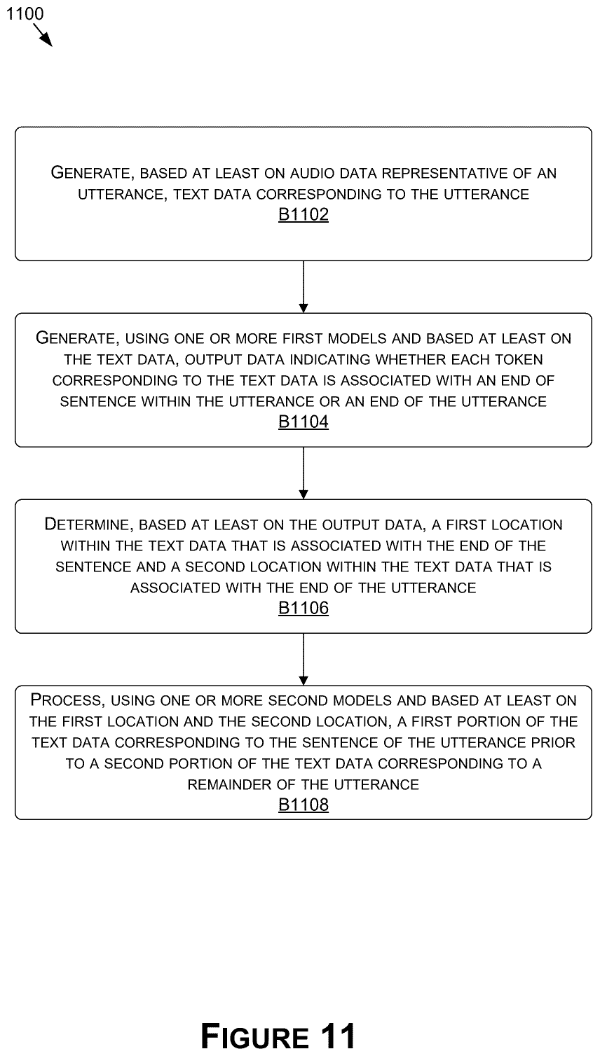

Now referring to FIGS. 11-13, each block of methods 1100, 1200, and 1300 described herein, comprises a computing process that may be performed using any combination of hardware, firmware, and/or software. For instance, various functions may be carried out by a processor executing instructions stored in memory. The method 1100, 1200, and 1300 may also be embodied as computer-usable instructions stored on computer storage media. The methods 1100, 1200, and 1300 may be provided by a standalone application, a service or hosted service (standalone or in combination with another hosted service), or a plug-in to another product, to name a few. In addition, the methods 1100, 1200, and 1300 are described, by way of example, with respect to the system of FIG. 1. However, these methods 1100, 1200, and 1300 may additionally or alternatively be executed by any one system, or any combination of systems, including, but not limited to, those described herein.

FIG. 11 illustrates a flow diagram showing a method 1100 for determining at least an end of sentence and an end of utterance associated with tokens, in accordance with some embodiments of the present disclosure. The method 1100, at block B1102, may include generating, based at least on audio data representative an utterance, text data corresponding to the utterance. For instance, the recognition model(s) 104 may process at least a portion of the audio data 102 representing the utterance. Based at least on the processing, the recognition model(s) 104 may generate the text data 106 associated with the utterance. As described herein, in some examples, the text data 106 may correspond to one or more tokens, such as one or more text tokens corresponding to text associated with the utterance. Additionally, in some examples, the encoder(s) 112 may then generate the embedding(s) 114 associated with the text data 106.

The method 1100, at block B1104, may include generating, using one or more first models and based at least on the text data, output data indicating whether each token corresponding to the text data is associated with an end of a sentence within the utterance or an end of the utterance. For instance, the detection model(s) 116 may generate the output data 118 based at least on the text data 106 (and/or the embedding(s) 114). As described herein, in some examples, the output data 118 may represent at least the word indicator(s) 120, the EOS indicator(s) 122, and/or the EOU indicator(s) 124 associated with each token. For instance, and for a token, the word indicator 120 may indicate whether the token is associated with a normal word, the EOS indicator 122 may indicate whether the token is associated with an EOS location, and the EOU indicator 124 may indicate whether the token is associated with an EOU location.

The method 1100, at block B1106, may include determining, based at least on the output data, a first location within the text data that is associated with the end of the sentence and a second location within the text data that is associated with the end of the utterance. For instance, the detection component(s) 126 may determine, based at least on the output data 118, the first location within the text data 106 that is associated with the EOS and the second location within the text data 106 that is associated with the EOU. As described herein, in some examples, the detection component(s) 126 may determine the first location is associated with the EOS based at least on a probability associated with a EOS indicator 122 including a highest probability and/or satisfying a threshold probability. Additionally, in some examples, the detection component(s) 126 may determine the second location is associated with the EOU based at least on a probability associated with an EOU indicator 124 including a highest probability and/or satisfying the threshold probability.

The method 1100, at block B1108, may include processing, using one or more second models and based at least on the first location and the second location, a first portion of the text data corresponding to the sentence of the utterance prior to processing a second portion of the text data corresponding to a remainder of the utterance. For instance, the language model(s) 108 may process the first portion of the text data 106 based at least on the EOS location being detected. Next, the language model(s) 108 may process the second portion of the text data 106 based at least on the EOU location being detected. As described herein, in some examples, the second portion of the text data 106 may represent the entire utterance and/or a portion of the utterance that is after the sentence. By detecting EOS for each sentence, the data corresponding to the sentence may be sent for processing prior to waiting for the entire utterance to be identified, which decreases latency (relative to prior approaches that waited for an entire utterance to be identified before sending for processing by a downstream model) and allows the model, in some instances, to have context for processing the entire utterance based on having already processed one or more sentences within the utterance identified using the EOS detection.

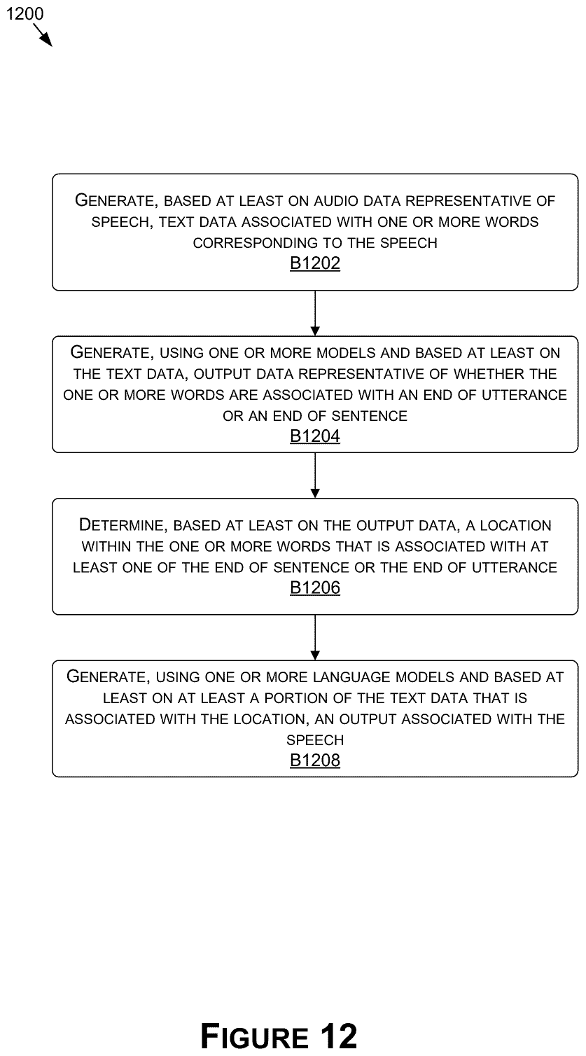

FIG. 12 illustrates a flow diagram showing a method 1200 for performing break detection in speech, in accordance with some embodiments of the present disclosure. The method 1200, at block B1202, may include generating, based at least on audio data representative of speech, text data associated with one or more words corresponding to the speech. For instance, the recognition model(s) 104 may process at least a portion of the audio data 102 representing the speech. Based at least on the processing, the recognition model(s) 104 may generate the text data 106 associated with the text corresponding to the speech. As described herein, in some examples, the text data 106 may represent one or more tokens, such as one or more text tokens, associated with the speech. Additionally, in some examples, the encoder(s) 112 may then generate the embedding(s) 114 associated with the text data 106.

The method 1200, at block B1204, may include generating, using one or more models and based at least on the text data, output data representative of whether the one or more words are associated with an end of sentence or an end of utterance. For instance, the detection model(s) 116 may generate the output data 118 based at least on the text data 106 (and/or the embedding(s) 114). As described herein, in some examples, the output data 118 may represent at least the word indicator(s) 120, the EOS indicator(s) 122, and/or the EOU indicator(s) 124 associated with the word(s) from the speech. Additionally, in some examples, the word indicator(s) 120, the EOS indicator(s) 122, and/or the EOU indicator(s) 124 may be associated with one or more probabilities.

The method 1200, at block B1206, may include determining, based at least on the output data, a location within the one or more words that is associated with at least one of the end of sentence or the end of utterance. For instance, the detection component(s) 126 may use the output data 118 to determine the location within the word(s) that is associated with the EOS or the EOU. As described herein, in some examples, the detection component(s) 126 may determine the location is associated with the EOS based at least on the probability associated with the EOS indicator 122 including a highest probability and/or satisfying a threshold probability. Additionally, in some examples, the detection component(s) 126 may determine the location is associated with the EOU based at least on the probability associated with the EOU indicator 124 including a highest probability and/or satisfying the threshold probability. Furthermore, in some examples, the detection component(s) 126 may include at least a portion of the detection model(s) 116.

The method 1200, at bock B1208, may include generating, using one or more language models and based at least on at least a portion of the text data that is associated with the location, an output associated with the speech. For instance, the at least the portion of the text data 106 may be processed by the language model(s) 108, where the at least the portion of the text data 106 is associated with the location. For instance, the at least the portion of the text data 106 may be associated with one or more words that start at a beginning word and then end at the location within the word(s). Additionally, based at least on processing the at least the portion of the text data 106, the language model(s) 108 may generate and/or output the output data 110 associated with the speech.

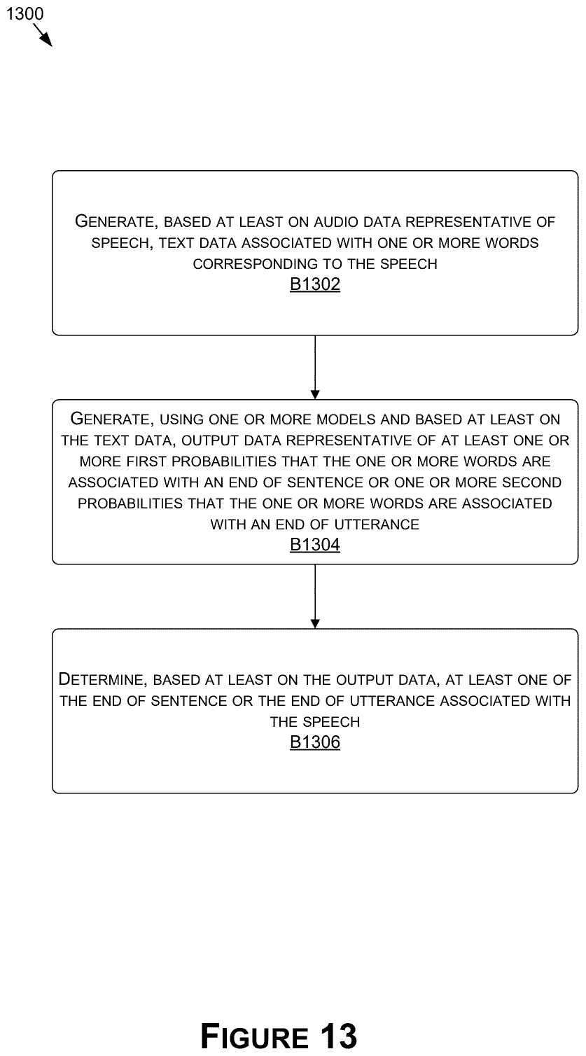

FIG. 13 illustrates a flow diagram showing a method 1300 for determining ends of sentences and ends of utterances associated with speech, in accordance with some embodiments of the present disclosure. The method 1300, at block B1302, may include generating, based at least on audio data representative of speech, text data associated with one or more words corresponding to the speech. For instance, the recognition model(s) 104 may process at least a portion of the audio data 102 representing the speech. Based at least on the processing, the recognition model(s) 104 may generate the text data 106 associated with the text corresponding to the speech. As described herein, in some examples, the text data 106 may represent one or more tokens, such as one or more text tokens, associated with the speech. Additionally, in some examples, the encoder(s) 112 may then generate the embedding(s) 114 associated with the text data 106.

The method 1300, at block B1304, may include generating, using one or more models and based at last on the text data, output data representative of at least one or more first probabilities that the one or more words are associated with an end of sentence and one or more second probabilities that the one or more words are associated with an end of utterance. For instance, the detection model(s) 116 may generate the output data 118 based at least on the text data 106 (and/or the embedding(s) 114), where the output data 118 represents the one or more first probabilities associated with the EOS indicator(s) 122 and the one or more second probabilities associated with the EOU indicator(s) 124.

The method 1300, at block B1306, may include determining, based at least on the output data, at least one of the end of sentence or the end of utterance associated with the speech. For instance, the detection component(s) 126 may use the one or more first probabilities and the one or more second probabilities to determine the EOS and/or the EOU. As described herein, in some examples, the detection component(s) 126 may determine the EOS based at least on a first probability associated with the EOS indicator 122 including a highest probability and/or satisfying a threshold probability. Additionally, in some examples, the detection component(s) 126 may determine the EOU based at least on a second probability associated with the EOU indicator 124 including a highest probability and/or satisfying the threshold probability. Furthermore, in some examples, the detection component(s) 126 may include at least a portion of the detection model(s) 116.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. patent application Ser. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

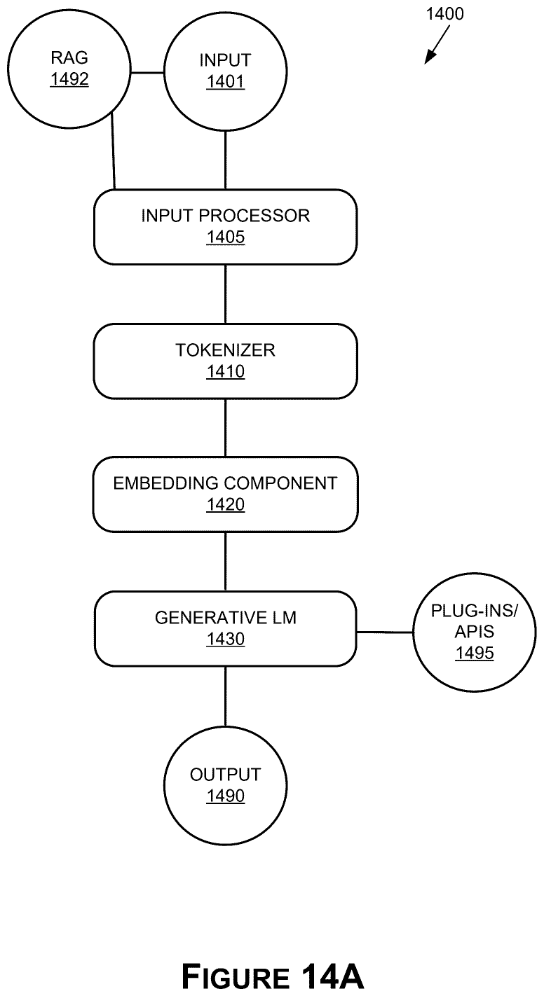

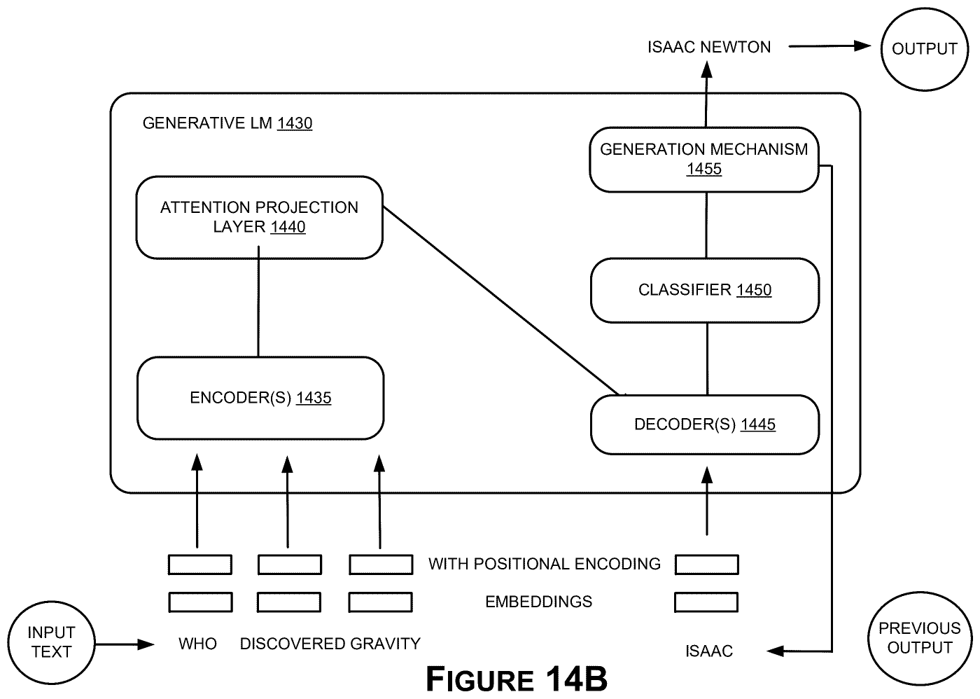

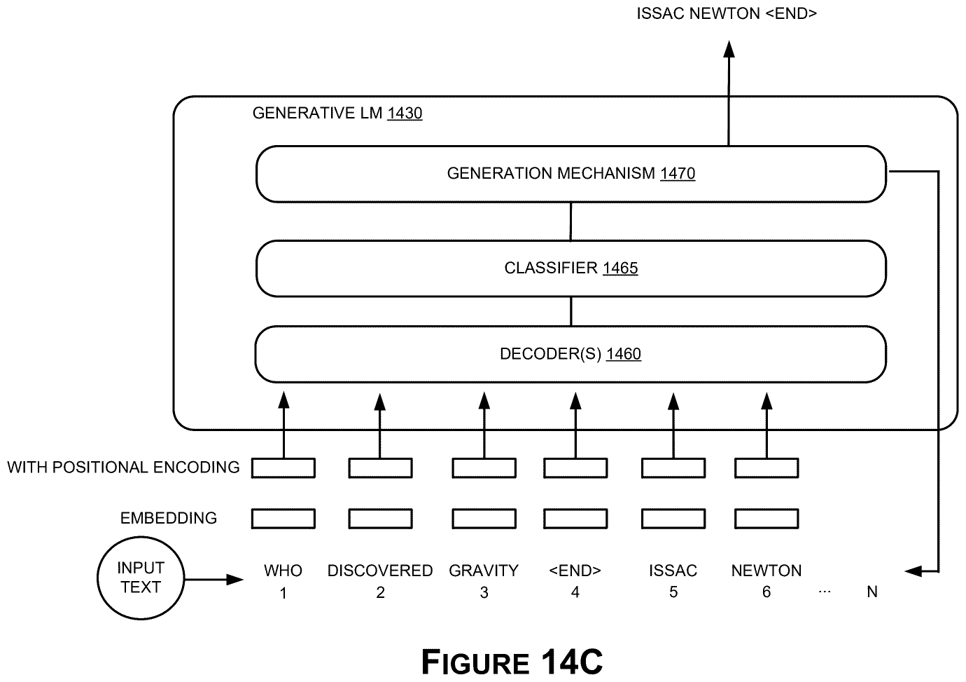

FIG. 14A is a block diagram of an example generative language model system 1400 suitable for use in implementing at least some embodiments of the present disclosure. In the example illustrated in FIG. 14A, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a multi-modal LM, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1430. In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multimodal inputs, the input 1401 may combine text with image data, audio data, and/or other types of input data, such as but not limited to those described herein. Taking raw input text as an example, the input processor 1405 may prepare raw input text in various ways. For example, the input processor 1405 may perform various types of text cleaning to remove noise (e.g., special characters, punctuation, HTML tags, stopwords) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1492 may be used to retrieve additional information to be used as part of the input 1401 or prompt. For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The tokenizer 1410 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data, the input processor 1401 may resize the image data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features—such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multimodal data, the embedding component 1420 may fuse representations of the different types of data (e.g., text, image, audio) using techniques like early fusion (concatenation), late fusion (sequential processing), attention-based fusion, etc.

The generative LM 1430 and/or other components of the generative LLM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using—plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

FIG. 14B is a block diagram of an example implementation in which the generative LM 1430 includes a transformer encoder-decoder. For example, assume input text such as “Who discovered gravity” is tokenized (e.g., by the tokenizer 1410 of FIG. 14A) into tokens such as words, and each token is encoded (e.g., by the embedding component 1420 of FIG. 914A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1435 of the generative LM 1430.

In an example implementation, the encoder(s) 1435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1440 may convert the context vector into attention vectors (keys and values) for the decoder(s) 1445.

In an example implementation, the decoder(s) 1445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1435, in an example transformer architecture, each token (e.g., word) flows through a separate path in the decoder(s) 1445. During a first pass, the decoder(s) 1445, a classifier 1450, and a generation mechanism 1455 may generate a first token, and the generation mechanism 1455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1435, except that it creates its queries from the layer below it and takes the keys and values (e.g., matrix) from the output of the encoder(s) 1435.

As such, the decoder(s) 1445 may output some decoded (e.g., vector) representation of the input being applied during a particular pass. The classifier 1450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1455 may select or sample a word or token based on a corresponding predicted probability (e.g., select the word with the highest predicted probability) and append it to the output from a previous pass, generating each word or token sequentially. The generation mechanism 1455 may repeat the process, triggering successive decoder inputs and corresponding predictions until selecting or sampling a symbol or token that represents the end of the response, at which point, the generation mechanism 1455 may output the generated response.

FIG. 14C is a block diagram of an example implementation in which the generative LM 1430 includes a decoder-only transformer architecture. For example, the decoder(s) 1460 of FIG. 14C may operate similarly as the decoder(s) 1445 of FIG. 14B except each of the decoder(s) 1460 of FIG. 14C omits the encoder-decoder self-attention layer (since there is no encoder in this implementation). As such, the decoder(s) 1460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1460. As with the decoder(s) 1445 of FIG. 14B, each token (e.g., word) may flow through a separate path in the decoder(s) 1460, and the decoder(s) 1460, a classifier 1465, and a generation mechanism 1470 may use auto-regression to sequentially generate one token at a time until predicting a symbol or token that represents the end of the response. The classifier 1465 and the generation mechanism 1470 may operate similarly as the classifier 1450 and the generation mechanism 1455 of FIG. 14B, with the generation mechanism 1470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

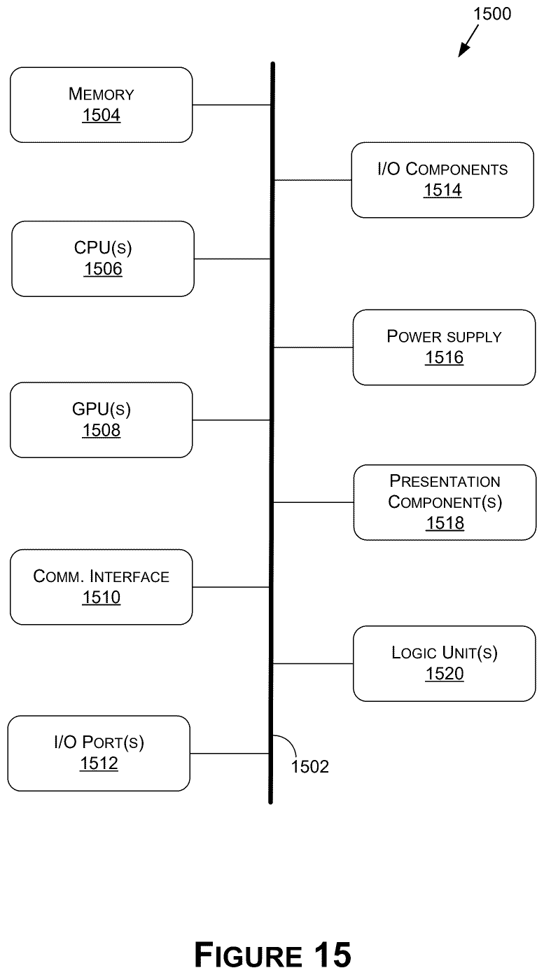

FIG. 15 is a block diagram of an example computing device(s) 1500 suitable for use in implementing some embodiments of the present disclosure. Computing device 1500 may include an interconnect system 1502 that directly or indirectly couples the following devices: memory 1504, one or more central processing units (CPUs) 1506, one or more graphics processing units (GPUs) 1508, a communication interface 1510, input/output (I/O) ports 1512, input/output components 1514, a power supply 1516, one or more presentation components 1518 (e.g., display(s)), and one or more logic units 1520. In at least one embodiment, the computing device(s) 1500 may comprise one or more virtual machines (VMs), and/or any of the components thereof may comprise virtual components (e.g., virtual hardware components). For non-limiting examples, one or more of the GPUs 1508 may comprise one or more vGPUs, one or more of the CPUs 1506 may comprise one or more vCPUs, and/or one or more of the logic units 1520 may comprise one or more virtual logic units. As such, a computing device(s) 1500 may include discrete components (e.g., a full GPU dedicated to the computing device 1500), virtual components (e.g., a portion of a GPU dedicated to the computing device 1500), or a combination thereof.

Although the various blocks of FIG. 15 are shown as connected via the interconnect system 1502 with lines, this is not intended to be limiting and is for clarity only. For example, in some embodiments, a presentation component 1518, such as a display device, may be considered an I/O component 1514 (e.g., if the display is a touch screen). As another example, the CPUs 1506 and/or GPUs 1508 may include memory (e.g., the memory 1504 may be representative of a storage device in addition to the memory of the GPUs 1508, the CPUs 1506, and/or other components). As such, the computing device of FIG. 15 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 15.

The interconnect system 1502 may represent one or more links or busses, such as an address bus, a data bus, a control bus, or a combination thereof. The interconnect system 1502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1506 may be directly connected to the memory 1504. Further, the CPU 1506 may be directly connected to the GPU 1508. Where there is direct, or point-to-point connection between components, the interconnect system 1502 may include a PCIe link to carry out the connection. In these examples, a PCI bus need not be included in the computing device 1500.

The memory 1504 may include any of a variety of computer-readable media. The computer-readable media may be any available media that may be accessed by the computing device 1500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1506 may be configured to execute at least some of the computer-readable instructions to control one or more components of the computing device 1500 to perform one or more of the methods and/or processes described herein. The CPU(s) 1506 may each include one or more cores (e.g., one, two, four, eight, twenty-eight, seventy-two, etc.) that are capable of handling a multitude of software threads simultaneously. The CPU(s) 1506 may include any type of processor, and may include different types of processors depending on the type of computing device 1500 implemented (e.g., processors with fewer cores for mobile devices and processors with more cores for servers). For example, depending on the type of computing device 1500, the processor may be an Advanced RISC Machines (ARM) processor implemented using Reduced Instruction Set Computing (RISC) or an x86 processor implemented using Complex Instruction Set Computing (CISC). The computing device 1500 may include one or more CPUs 1506 in addition to one or more microprocessors or supplementary co-processors, such as math co-processors.

In addition to or alternatively from the CPU(s) 1506, the GPU(s) 1508 may be configured to execute at least some of the computer-readable instructions to control one or more components of the computing device 1500 to perform one or more of the methods and/or processes described herein. One or more of the GPU(s) 1508 may be an integrated GPU (e.g., with one or more of the CPU(s) 1506 and/or one or more of the GPU(s) 1508 may be a discrete GPU. In embodiments, one or more of the GPU(s) 1508 may be a coprocessor of one or more of the CPU(s) 1506. The GPU(s) 1508 may be used by the computing device 1500 to render graphics (e.g., 3D graphics) or perform general purpose computations. For example, the GPU(s) 1508 may be used for General-Purpose computing on GPUs (GPGPU). The GPU(s) 1508 may include hundreds or thousands of cores that are capable of handling hundreds or thousands of software threads simultaneously. The GPU(s) 1508 may generate pixel data for output images in response to rendering commands (e.g., rendering commands from the CPU(s) 1506 received via a host interface). The GPU(s) 1508 may include graphics memory, such as display memory, for storing pixel data or any other suitable data, such as GPGPU data. The display memory may be included as part of the memory 1504. The GPU(s) 1508 may include two or more GPUs operating in parallel (e.g., via a link). The link may directly connect the GPUs (e.g., using NVLINK) or may connect the GPUs through a switch (e.g., using NVSwitch). When combined together, each GPU 1508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1506 and/or the GPU(s) 1508, the logic unit(s) 1520 may be configured to execute at least some of the computer-readable instructions to control one or more components of the computing device 1500 to perform one or more of the methods and/or processes described herein. In embodiments, the CPU(s) 1506, the GPU(s) 1508, and/or the logic unit(s) 1520 may discretely or jointly perform any combination of the methods, processes and/or portions thereof. One or more of the logic units 1520 may be part of and/or integrated in one or more of the CPU(s) 1506 and/or the GPU(s) 1508 and/or one or more of the logic units 1520 may be discrete components or otherwise external to the CPU(s) 1506 and/or the GPU(s) 1508. In embodiments, one or more of the logic units 1520 may be a coprocessor of one or more of the CPU(s) 1506 and/or one or more of the GPU(s) 1508.

Examples of the logic unit(s) 1520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1510 may include one or more receivers, transmitters, and/or transceivers that allow the computing device 1500 to communicate with other computing devices via an electronic communication network, included wired and/or wireless communications. The communication interface 1510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1520 and/or communication interface 1510 may include one or more data processing units (DPUs) to transmit data received over a network and/or through interconnect system 1502 directly to (e.g., a memory of) one or more GPU(s) 1508.

The I/O ports 1512 may allow the computing device 1500 to be logically coupled to other devices including the I/O components 1514, the presentation component(s) 1518, and/or other components, some of which may be built in to (e.g., integrated in) the computing device 1500. Illustrative I/O components 1514 include a microphone, mouse, keyboard, joystick, game pad, game controller, satellite dish, scanner, printer, wireless device, etc. The I/O components 1514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 may be include depth cameras, such as stereoscopic camera systems, infrared camera systems, RGB camera systems, touchscreen technology, and combinations of these, for gesture detection and recognition. Additionally, the computing device 1500 may include accelerometers or gyroscopes (e.g., as part of an inertia measurement unit (IMU)) that allow detection of motion. In some examples, the output of the accelerometers or gyroscopes may be used by the computing device 1500 to render immersive augmented reality or virtual reality.

The power supply 1516 may include a hard-wired power supply, a battery power supply, or a combination thereof. The power supply 1516 may provide power to the computing device 1500 to allow the components of the computing device 1500 to operate.

The presentation component(s) 1518 may include a display (e.g., a monitor, a touch screen, a television screen, a heads-up-display (HUD), other display types, or a combination thereof), speakers, and/or other presentation components. The presentation component(s) 1518 may receive data from other components (e.g., the GPU(s) 1508, the CPU(s) 1506, DPUs, etc.), and output the data (e.g., as an image, video, sound, etc.).

### Example Data Center

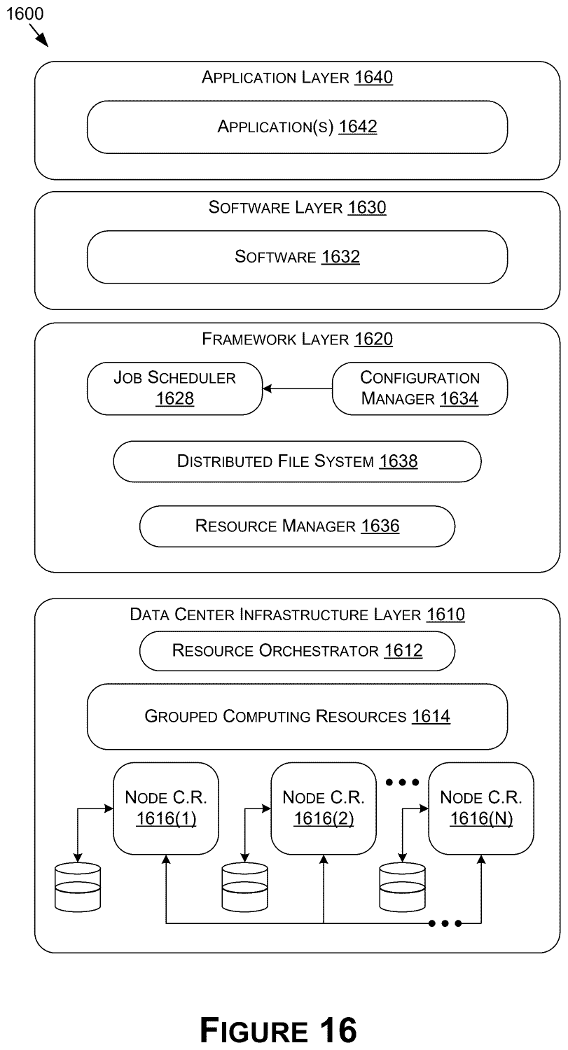

FIG. 16 illustrates an example data center 1600 that may be used in at least one embodiments of the present disclosure. The data center 1600 may include a data center infrastructure layer 1610, a framework layer 1620, a software layer 1630, and/or an application layer 1640.

As shown in FIG. 16, the data center infrastructure layer 1610 may include a resource orchestrator 1612, grouped computing resources 1614, and node computing resources (“node C.R.s”) 1616(1)-1616(N), where “N” represents any whole, positive integer. In at least one embodiment, node C.R.s 1616(1)-1616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1616(1)-1616(N) may correspond to a server having one or more of the above-mentioned computing resources. In addition, in some embodiments, the node C.R.s 1616(1)-16161(N) may include one or more virtual components, such as vGPUs, vCPUs, and/or the like, and/or one or more of the node C.R.s 1616(1)-1616(N) may correspond to a virtual machine (VM).

In at least one embodiment, grouped computing resources 1614 may include separate groupings of node C.R.s 1616 housed within one or more racks (not shown), or many racks housed in data centers at various geographical locations (also not shown). Separate groupings of node C.R.s 1616 within grouped computing resources 1614 may include grouped compute, network, memory or storage resources that may be configured or allocated to support one or more workloads. In at least one embodiment, several node C.R.s 1616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1612 may configure or otherwise control one or more node C.R.s 1616(1)-1616(N) and/or grouped computing resources 1614. In at least one embodiment, resource orchestrator 1612 may include a software design infrastructure (SDI) management entity for the data center 1600. The resource orchestrator 1612 may include hardware, software, or some combination thereof.

In at least one embodiment, as shown in FIG. 16, framework layer 1620 may include a job scheduler 1628, a configuration manager 1634, a resource manager 1636, and/or a distributed file system 1638. The framework layer 1620 may include a framework to support software 1632 of software layer 1630 and/or one or more application(s) 1642 of application layer 1640. The software 1632 or application(s) 1642 may respectively include web-based service software or applications, such as those provided by Amazon Web Services, Google Cloud and Microsoft Azure. The framework layer 1620 may be, but is not limited to, a type of free and open-source software web application framework such as Apache Spark™ (hereinafter “Spark”) that may use distributed file system 1638 for large-scale data processing (e.g., “big data”). In at least one embodiment, job scheduler 1628 may include a Spark driver to facilitate scheduling of workloads supported by various layers of data center 1600. The configuration manager 1634 may be capable of configuring different layers such as software layer 1630 and framework layer 1620 including Spark and distributed file system 1638 for supporting large-scale data processing. The resource manager 1636 may be capable of managing clustered or grouped computing resources mapped to or allocated for support of distributed file system 1638 and job scheduler 1628. In at least one embodiment, clustered or grouped computing resources may include grouped computing resource 1614 at data center infrastructure layer 1610. The resource manager 1636 may coordinate with resource orchestrator 1612 to manage these mapped or allocated computing resources.

In at least one embodiment, software 1632 included in software layer 1630 may include software used by at least portions of node C.R.s 1616(1)-1616(N), grouped computing resources 1614, and/or distributed file system 1638 of framework layer 1620. One or more types of software may include, but are not limited to, Internet web page search software, e-mail virus scan software, database software, and streaming video content software.

In at least one embodiment, application(s) 1642 included in application layer 1640 may include one or more types of applications used by at least portions of node C.R.s 1616(1)-1616(N), grouped computing resources 1614, and/or distributed file system 1638 of framework layer 1620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1634, resource manager 1636, and resource orchestrator 1612 may implement any number and type of self-modifying actions based on any amount and type of data acquired in any technically feasible fashion. Self-modifying actions may relieve a data center operator of data center 1600 from making possibly bad configuration decisions and possibly avoiding underutilized and/or poor performing portions of a data center.

The data center 1600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1600. In at least one embodiment, trained or deployed machine learning models corresponding to one or more neural networks may be used to infer or predict information using resources described above with respect to the data center 1600 by using weight parameters calculated through one or more training techniques, such as but not limited to those described herein.

In at least one embodiment, the data center 1600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1500 of FIG. 15—e.g., each device may include similar components, features, and/or functionality of the computing device(s) 1500. In addition, where backend devices (e.g., servers, NAS, etc.) are implemented, the backend devices may be included as part of a data center 1600, an example of which is described in more detail herein with respect to FIG. 16.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1500 described herein with respect to FIG. 15. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, based at least on audio data representative an utterance, text data corresponding to the utterance; generating, using one or more first models and based at least on the text data, output data indicating whether each token corresponding to the text data is associated with an end of a sentence within the utterance or an end of the utterance; determining, based at least on the output data, a first location within the text data that is associated with the end of the sentence and a second location within the text data that is associated with the end of the utterance; and processing, using one or more second models and based at least on the first location and the second location, a first portion of the text data corresponding to the sentence of the utterance prior to processing a second portion of the text data corresponding to a remainder of the utterance.

B: The method of paragraph A, wherein the output data represents at least; first probabilities indicating whether each token is associated with the end of the sentence; second probabilities indicating whether each token is associated with the end of the utterance; and third probabilities indicating whether each token is not associated with the end of the sentence and the end of the utterance.

C: The method of either paragraph A or paragraph B, further comprising: generating, using one or more second models and based at least on the text data, second output data representative of whether each token is associated with a lowercase word or an uppercase word, wherein the determining the first location and the second location is further based at least on the second output data.

D: The method of any one of paragraphs A-C, further comprising: generating, using the one or more second models and based at least on the text data, second output data representative of whether each token is associated with one or more types of punctuation marks, wherein the determining the first location and the second location is further based at least on the second output data.

E: The method of any one of paragraphs A-D, further comprising: generating, using one or more first encoders and based at least on the audio data, one or more first embeddings; generating, using one or more second encoders and based at least on the text data, one or more second embeddings; and generating input data based at least on the one or more first embeddings and the one or more second embeddings, wherein the generating the output data uses the one or more models and is based at least on the input data.

F: The method of any one of paragraphs A-E, wherein the first portion of the text data is processed using the one or more second models based at least on determining the first location and prior to determining the second location.

G: A system comprising: one or more processors to: determine, using one or more models and based at least on text data associated with one or more words, an output indicating whether the one or more words are associated an end of sentence and whether the one or more words are associated with an end of utterance; and cause, based at least on the output, processing of at least a portion of the text data.

H: The system of paragraph G, wherein the one or more processors are further to: determine, based at least on the output, that a first word of the one or more words is associated with the end of sentence; determine the at least the portion of the text data based at least on the first word being associated with the end of sentence; determine, based at least on the output, that a second word of the one or more words is associated with the end of utterance; determine at least a second portion of the text data based at least on the second word being associated with the end of utterance; and cause processing of the at least the second portion of the text data.

I: The system of paragraph H, wherein the at least the portion of the text data is processed prior to the at least the second portion of the text data.

J: The system of any one of paragraphs G-I, wherein the output represents at least; one or more first probabilities indicating whether the one or more words are associated with the end of sentence; and one or more second probabilities indicating whether the one or more words are associated with the end of utterance.

K: The system of any one of paragraphs G-J, wherein the one or more words include a plurality of words, and wherein the output represents at least: one or more first indicators that one or more first words from the plurality of words are associated with the end of sentence; and one or more second indicators that one or more second words from the plurality of words are associated with the end of utterance.

L: The system of any one of paragraphs G-K, wherein the one or more processors are further to: determine, using one or more second models and based at least on the text data, a second output indicating whether the one or more words are at least one of lowercase or uppercase, wherein the processing of the at least the portion of the text data is further caused based at least on the second output.

M: The system of paragraph L, wherein the second output represents at least: one or more first probabilities indicating whether the one or more words are lowercase; and one or more second probabilities indicating whether the one or more words are uppercase.

N: The system of any one of paragraphs G-M, wherein the one or more processors are further to: determine, using one or more second models and based at least on the text data, a second output indicating whether the one or more words are associated with one or more types of punctuation marks, wherein the processing of the at least the portion of the text data is further caused based at least on the second output.

O: The system of paragraph N, wherein the second output represents at least: one or more first probabilities indicating whether the one or more words are associated with one or more first types of punctuation marks; and one or more second probabilities indicating whether the one or more words are associated with one or more second types of punctuation marks.

P: The system of any one of paragraphs G-O, wherein the one or more processors are further to: generate, using one or more encoders and based at least on audio data, one or more first embeddings; generate, using the one or more encoders and based at least on the text data, one or more second embeddings; and generate input data based at least on the one or more first embeddings and the one or more second embeddings, wherein the determination of the output is based at least on the input data.

Q: The system of any one of paragraphs G-P, wherein: the text data represents one or more tokens associated with the one or more words; and the output indicates whether the one or more tokens are associated with the end of sentence or whether the one or more tokens are associated with the end of utterance.

R: The system of any one of paragraphs G-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to process at least a first portion of text data at a first instance and a second portion of the text data at a second instance based at least on an output indicating that the first portion of the text data is associated with an end of a sentence and the second portion of the text data is associated with an end of an utterance that includes the sentence, wherein the output is generated based at least on one or more models processing the text data.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more visual language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, based at least on audio data representative an utterance, text data corresponding to the utterance;
generating, using one or more first models and based at least on the text data, output data indicating whether each token corresponding to the text data is associated with an end of a sentence within the utterance or an end of the utterance;
determining, based at least on the output data, a first location within the text data that is associated with the end of the sentence and a second location within the text data that is associated with the end of the utterance; and
processing, using one or more second models and based at least on the first location and the second location, a first portion of the text data corresponding to the sentence of the utterance prior to processing a second portion of the text data corresponding to a remainder of the utterance.

2. The method of claim 1, wherein the output data represents at least;
first probabilities indicating whether each token is associated with the end of the sentence;
second probabilities indicating whether each token is associated with the end of the utterance; and
third probabilities indicating whether each token is not associated with the end of the sentence and the end of the utterance.

3. The method of claim 1, further comprising:
generating, using one or more second models and based at least on the text data, second output data representative of whether each token is associated with a lowercase word or an uppercase word,
wherein the determining the first location and the second location is further based at least on the second output data.

4. The method of claim 1, further comprising:
generating, using the one or more second models and based at least on the text data, second output data representative of whether each token is associated with one or more types of punctuation marks,
wherein the determining the first location and the second location is further based at least on the second output data.

5. The method of claim 1, further comprising:
generating, using one or more first encoders and based at least on the audio data, one or more first embeddings;
generating, using one or more second encoders and based at least on the text data, one or more second embeddings; and
generating input data based at least on the one or more first embeddings and the one or more second embeddings,
wherein the generating the output data uses the one or more models and is based at least on the input data.

6. The method of claim 1, wherein the first portion of the text data is processed using the one or more second models based at least on determining the first location and prior to determining the second location.

7. A system comprising:
one or more processors to:
determine, using one or more models and based at least on text data associated with one or more words, an output indicating whether the one or more words are associated an end of sentence and whether the one or more words are associated with an end of utterance; and
cause, based at least on the output, processing of at least a portion of the text data.

8. The system of claim 7, wherein the one or more processors are further to:
determine, based at least on the output, that a first word of the one or more words is associated with the end of sentence;
determine the at least the portion of the text data based at least on the first word being associated with the end of sentence;
determine, based at least on the output, that a second word of the one or more words is associated with the end of utterance;
determine at least a second portion of the text data based at least on the second word being associated with the end of utterance; and
cause processing of the at least the second portion of the text data.

9. The system of claim 8, wherein the at least the portion of the text data is processed prior to the at least the second portion of the text data.

10. The system of claim 7, wherein the output represents at least;
one or more first probabilities indicating whether the one or more words are associated with the end of sentence; and
one or more second probabilities indicating whether the one or more words are associated with the end of utterance.

11. The system of claim 7, wherein the one or more words include a plurality of words, and wherein the output represents at least:
one or more first indicators that one or more first words from the plurality of words are associated with the end of sentence; and
one or more second indicators that one or more second words from the plurality of words are associated with the end of utterance.

12. The system of claim 7, wherein the one or more processors are further to:
determine, using one or more second models and based at least on the text data, a second output indicating whether the one or more words are at least one of lowercase or uppercase,
wherein the processing of the at least the portion of the text data is further caused based at least on the second output.

13. The system of claim 12, wherein the second output represents at least:
one or more first probabilities indicating whether the one or more words are lowercase; and
one or more second probabilities indicating whether the one or more words are uppercase.

14. The system of claim 7, wherein the one or more processors are further to:
determine, using one or more second models and based at least on the text data, a second output indicating whether the one or more words are associated with one or more types of punctuation marks,
wherein the processing of the at least the portion of the text data is further caused based at least on the second output.

15. The system of claim 14, wherein the second output represents at least:
one or more first probabilities indicating whether the one or more words are associated with one or more first types of punctuation marks; and
one or more second probabilities indicating whether the one or more words are associated with one or more second types of punctuation marks.

16. The system of claim 7, wherein the one or more processors are further to:
generate, using one or more encoders and based at least on audio data, one or more first embeddings;
generate, using the one or more encoders and based at least on the text data, one or more second embeddings; and
generate input data based at least on the one or more first embeddings and the one or more second embeddings,
wherein the determination of the output is based at least on the input data.

17. The system of claim 7, wherein:
the text data represents one or more tokens associated with the one or more words; and
the output indicates whether the one or more tokens are associated with the end of sentence or whether the one or more tokens are associated with the end of utterance.

18. The system of claim 7, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to process at least a first portion of text data at a first instance and a second portion of the text data at a second instance based at least on an output indicating that the first portion of the text data is associated with an end of a sentence and the second portion of the text data is associated with an end of an utterance that includes the sentence, wherein the output is generated based at least on one or more models processing the text data.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more visual language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
